(19) United States
(12) Patent Application Publication
(10) Pub. No.: US 2020/0382809 A1
(43) Pub. Date: Dec. 3, 2020

(54) SYSTEMS AND METHODS FOR SIGNALING OF INFORMATION ASSOCIATED WITH MOST-INTERESTED REGIONS FOR VIRTUAL REALITY APPLICATIONS

(71) Applicant: SHARP KABUSHIK! KAiSHA, Sakai City, Osaka (JP)

(72) Inventor: SACHIN G. DESHPANDE, Vancouver, WA (US)

(21) Appl. No.: 16/497,202

(22) PCT Filed: Feb. 9, 2018
(86) PCT No.: PCT/JP2018/004574

§ 371 Date: Sep. 24, 2019

Related U.S. Application Data
(60) Provisional application No. 62/477,379, filed on Mar. 27, 2017.
(60) Provisional application No. 62/479,162, filed on Mar. 30, 2017.
(60) Provisional application No. 62/482,124, filed on Apr. 5, 2017.
(60) Provisional application No. 62/482,289, filed on Apr. 6, 2017.

(51) Int. Cl. H04N 19/70; H04N 19/597; H04N 21/2343; H04N 21/235; H04N 21/81

(52) U.S. Cl. CPC H04N 19/70; H04N 19/597; H04N 21/816; H04N 21/235; H04N 21/234345

(57) ABSTRACT

A device may be configured to signal information (See “region_on_frame_flag” in paragraph [0070].) associated with most-interested regions of an omnidirectional video according to one or more of the techniques described herein.

### CROSS REFERENCE

This Nonprovisional application claims priority under 35 U.S.C. § 119 on provisional Application No. 62/477,379 on Mar. 27, 2017, No. 62/479,162 on Mar. 30, 2017, No. 62/482,124 on Apr. 5, 2017, No. 62/482,289 on Apr. 6, 2017, the entire contents of which are hereby incorporated by reference.

### TECHNICAL FIELD

This disclosure relates to interactive video distribution and more particularly to techniques for signaling of information associated with most-interested regions of video.

### BACKGROUND ART

Digital media playback capabilities may be incorporated into a wide range of devices, including digital televisions, including so-called “smart” televisions, set-top boxes, laptop or desktop computers, tablet computers, digital recording devices, digital media players, video gaming devices, cellular phones, including so-called “smart” phones, dedicated video streaming devices, and the like. Digital media content (e.g., video and audio programming) may originate from a plurality of sources including, for example, over-the-air television providers, satellite television providers, cable television providers, online media service providers, including, so-called streaming service providers, and the like. Digital media content may be delivered over packet-switched networks, including bidirectional networks, such as Internet Protocol (IP) networks and unidirectional networks, such as digital broadcast networks.

Digital video included in digital media content may be coded according to a video coding standard. Video coding standards may incorporate video compression techniques. Examples of video coding standards include ISO/IEC MPEG-4 Visual and ITU-T H.264 (also known as ISO/IEC MPEG-4 AVC) and High-Efficiency Video Coding (HEVC). Video compression techniques enable data requirements for storing and transmitting video data to be reduced. Video compression techniques may reduce data requirements by exploiting the inherent redundancies in a video sequence. Video compression techniques may sub-divide a video sequence into successively smaller portions (i.e., groups of frames within a video sequence, a frame within a group of frames, slices within a frame, coding tree units (e.g., macroblocks) within a slice, coding blocks within a coding tree unit, etc.). Prediction coding techniques may be used to generate difference values between a unit of video data to be coded and a reference unit of video data. The difference values may be referred to as residual data. Residual data may be coded as quantized transform coefficients. Syntax elements may relate residual data and a reference coding unit. Residual data and syntax elements may be included in a compliant bitstream. Compliant bitstreams and associated metadata may be formatted according to data structures. Compliant bitstreams and associated metadata may be transmitted from a source to a receiver device (e.g., a digital television or a smart phone) according to a transmission standard. Examples of transmission standards include Digital Video Broadcasting (DVB) standards, Integrated Services Digital Broadcasting Standards (ISDB) standards, and standards developed by the Advanced Television Systems Committee (ATSC), including, for example, the ATSC 2.0 standard. The ATSC is currently developing the so-called ATSC 3.0 suite of standards.

### SUMMARY OF INVENTION

In one example, a method of signaling of information associated with a most-interested region of an omnidirectional video, comprising signaling a syntax element indicating whether a position and size of a region are indicated on a packed frame or a projected frame.

### BRIEF DESCRIPTION OF DRAWINGS

FIG. 1 is a block diagram illustrating an example of a system that may be configured to transmit coded video data according to one or more techniques of this this disclosure.

FIG. 2A is a conceptual diagram illustrating coded video data and corresponding data structures according to one or more techniques of this this disclosure.

FIG. 2B is a conceptual diagram illustrating coded video data and corresponding data structures according to one or more techniques of this this disclosure.

FIG. 3 is a conceptual diagram illustrating coded video data and corresponding data structures according to one or more techniques of this this disclosure.

FIG. 4 is a conceptual drawing illustrating an example of components that may be included in an implementation of a system that may be configured to distribute coded video data according to one or more techniques of this this disclosure.

FIG. 5 is a block diagram illustrating an example of a receiver device that may implement one or more techniques of this disclosure.

FIG. 6A is a conceptual drawing illustrating examples of regions on a sphere according to one or more techniques of this disclosure.

FIG. 6B is a conceptual drawing illustrating examples of regions on a sphere according to one or more techniques of this disclosure.

### DESCRIPTION OF EMBODIMENTS

In general, this disclosure describes various techniques for coding video data. In particular, this disclosure describes techniques for signaling of information associated with most-interested regions of omnidirectional video. Signaling of information according to the techniques described herein may be particularly useful for improving video distribution system performance by lowering transmission bandwidth and/or lowering coding complexity. It should be noted that although techniques of this disclosure are described with respect to ITU-T H.264 and ITU-T H.265, the techniques of this disclosure are generally applicable to video coding. For example, the coding techniques described herein may be incorporated into video coding systems, (including video coding systems based on future video coding standards) including block structures, intra prediction techniques, inter prediction techniques, transform techniques, filtering techniques, and/or entropy coding techniques other than those included in ITU-T H.265. Thus, reference to ITU-T H.264 and ITU-T H.265 is for descriptive purposes and should not be construed to limit the scope of the techniques described herein. Further, it should be noted that incorporation by reference of documents herein should not be construed to limit or create ambiguity with respect to terms used herein. For example, in the case where an incorporated reference provides a different definition of a term than another incorporated reference and/or as the term is used herein, the term should be interpreted in a manner that broadly includes each respective definition and/or in a manner that includes each of the particular definitions in the alternative.

In one example, a device comprises one or more processors configured to signal a syntax element indicating whether a position and size of a region are indicated on a packed frame or a projected frame.

In one example, a non-transitory computer-readable storage medium comprises instructions stored thereon that, when executed, cause one or more processors of a device to signal a syntax element indicating whether a position and size of a region are indicated on a packed frame or a projected frame.

In one example, an apparatus comprises means for signaling a syntax element indicating whether a position and size of a region are indicated on a packed frame or a projected frame.

The details of one or more examples are set forth in the accompanying drawings and the description below. Other features, objects, and advantages will be apparent from the description and drawings, and from the claims.

Video content typically includes video sequences comprised of a series of frames. A series of frames may also be referred to as a group of pictures (GOP). Each video frame or picture may include a one or more slices, where a slice includes a plurality of video blocks. A video block may be defined as the largest array of pixel values (also referred to as samples) that may be predictively coded. Video blocks may be ordered according to a scan pattern (e.g., a raster scan). A video encoder performs predictive encoding on video blocks and sub-divisions thereof. ITU-T H.264 specifies a macroblock including 16×16 luma samples. ITU-T H.265 specifies an analogous Coding Tree Unit (CTU) structure where a picture may be split into CTUs of equal size and each CTU may include Coding Tree Blocks (CTB) having 16×16, 32×32, or 64×64 luma samples. As used herein, the term video block may generally refer to an area of a picture or may more specifically refer to the largest array of pixel values that may be predictively coded, sub-divisions thereof, and/or corresponding structures. Further, according to ITU-T H.265, each video frame or picture may be partitioned to include one or more tiles, where a tile is a sequence of coding tree units corresponding to a rectangular area of a picture.

In ITU-T H.265, the CTBs of a CTU may be partitioned into Coding Blocks (CB) according to a corresponding quadtree block structure. According to ITU-T H.265, one luma CB together with two corresponding chroma CBs and associated syntax elements are referred to as a coding unit (CU). A CU is associated with a prediction unit (PU) structure defining one or more prediction units (PU) for the CU, where a PU is associated with corresponding reference samples. That is, in ITU-T H.265 the decision to code a picture area using intra prediction or inter prediction is made at the CU level and for a CU one or more predictions corresponding to intra prediction or inter prediction may be used to generate reference samples for CBs of the CU. In ITU-T H.265, a PU may include luma and chroma prediction blocks (PBs), where square PBs are supported for intra prediction and rectangular PBs are supported for inter prediction. Intra prediction data (e.g., intra prediction mode syntax elements) or inter prediction data (e.g., motion data syntax elements) may associate PUs with corresponding reference samples. Residual data may include respective arrays of difference values corresponding to each component of video data (e.g., luma (Y) and chroma (Cb and Cr)). Residual data may be in the pixel domain. A transform, such as, a discrete cosine transform (DCT), a discrete sine transform (DST), an integer transform, a wavelet transform, or a conceptually similar transform, may be applied to pixel difference values to generate transform coefficients. It should be noted that in ITU-T H.265, CUs may be further sub-divided into Transform Units (TUs). That is, an array of pixel difference values may be sub-divided for purposes of generating transform coefficients (e.g., four 8×8 transforms may be applied to a 16×16 array of residual values corresponding to a 16×16 luma CB), such sub-divisions may be referred to as Transform Blocks (TBs). Transform coefficients may be quantized according to a quantization parameter (QP). Quantized transform coefficients (which may be referred to as level values) may be entropy coded according to an entropy encoding technique (e.g., content adaptive variable length coding (CAVLC), context adaptive binary arithmetic coding (CABAC), probability interval partitioning entropy coding (PIPE), etc.). Further, syntax elements, such as, a syntax element indicating a prediction mode, may also be entropy coded. Entropy encoded quantized transform coefficients and corresponding entropy encoded syntax elements may form a compliant bitstream that can be used to reproduce video data. A binarization process may be performed on syntax elements as part of an entropy coding process. Binarization refers to the process of converting a syntax value into a series of one or more bits. These bits may be referred to as “bins.”

Virtual Reality (VR) applications may include video content that may be rendered with a head-mounted display, where only the area of the spherical video that corresponds to the orientation of the user's head is rendered. VR applications may be enabled by omnidirectional video, which is also referred to as 360 degree spherical video or 360 degree video. Omnidirectional video is typically captured by multiple cameras that cover up to 360 degrees of a scene. A distinct feature of omnidirectional video compared to normal video is that, typically only a subset of the entire captured video region is displayed, i.e., the area corresponding to the current user's field of view (FOV) is displayed. A FOV is sometimes also referred to as viewport. In other cases, a viewport may be part of the spherical video that is currently displayed and viewed by the user. It should be noted that the size of the viewport can be smaller than or equal to the field of view. Further, it should be noted that omnidirectional video may be captured using monoscopic or stereoscopic cameras. Monoscopic cameras may include cameras that capture a single view of an object. Stereoscopic cameras may include cameras that capture multiple views of the same object (e.g., views are captured using two lenses at slightly different angles). Further, it should be noted that in some cases, images for use in omnidirectional video applications may be captured using ultra wide-angle lens (i.e., so-called fisheye lens). In any case, the process for creating 360 degree spherical video may be generally described as stitching together input images and projecting the stitched together input images onto a three-dimensional structure (e.g., a sphere or cube), which may result in so-called projected frames. Further, in some cases, regions of projected frames may be transformed, resized, and relocated, which may result in a so-called packed frame.

A most-interested region in an omnidirectional video picture may refer to a subset of the entire video region that is statistically the most likely to be rendered to the user at the presentation time of that picture (i.e., most likely to be in a FOV). It should be noted that most-interested regions of an omnidirectional video may be determined by the intent of a director or producer, or derived from user statistics by a service or content provider (e.g., through the statistics of which regions have been requested/seen by the most users when the omnidirectional video content was provided through a streaming service). Most-interested regions may be used for data pre-fetching in omnidirectional video adaptive streaming by edge servers or clients, and/or transcoding optimization when an omnidirectional video is transcoded, e.g., to a different codec or projection mapping. Thus, signaling most-interested regions in an omnidirectional video picture may improve system performance by lowering transmission bandwidth and lowering decoding complexity. It should be noted that most-interested region may in some cases be referred to as most-interesting region or as region-of-interest.

Choi et al., ISO/IEC JTC1/SC29/WG11 N16636, “MPEG-A Part 20 (WD on ISO/IEC 23000-20): Omnidirectional Media Application Format,” January 2017, Geneva, CH, which is incorporated by reference and herein referred to as Choi, defines a media application format that enables omnidirectional media applications. Choi specifies a list of projection techniques that can be used for conversion of a spherical or 360 degree video into a two-dimensional rectangular video; how to store omnidirectional media and the associated metadata using the International Organization for Standardization (ISO) base media file format (ISOBMFF); how to encapsulate, signal, and stream omnidirectional media using dynamic adaptive streaming over Hypertext Transfer Protocol (HTTP) (DASH); and which video and audio coding standards, as well as media coding configurations, may be used for compression and playback of the omnidirectional media signal.

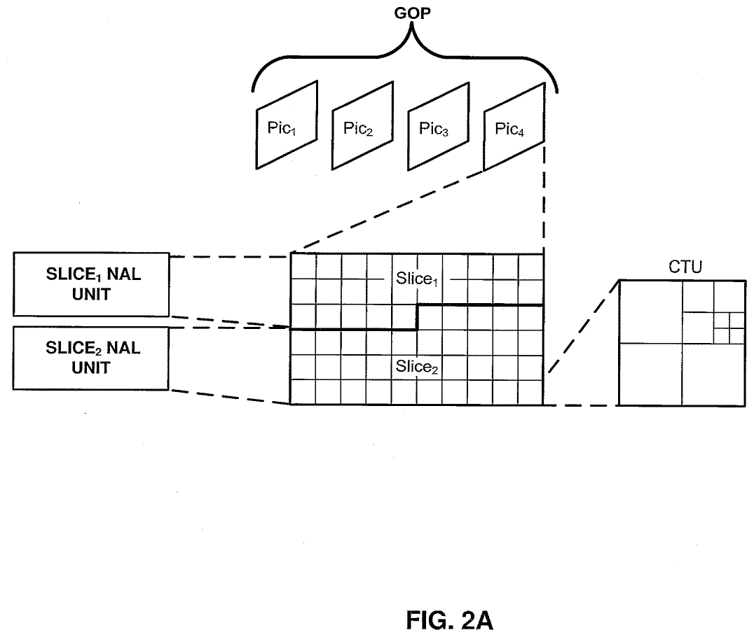

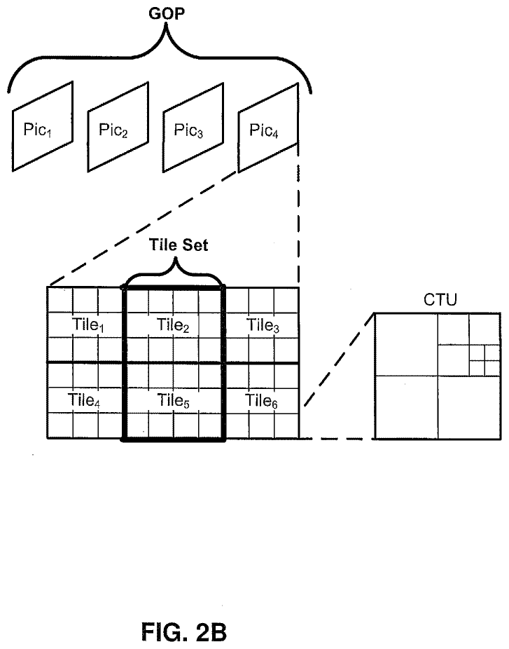

As described above, according to ITU-T H.265, each video frame or picture may be partitioned to include one or more slices and further partitioned to include one or more tiles. FIGS. 2A-2B are conceptual diagrams illustrating an example of a group of pictures including slices and further partitioning pictures into tiles. In the example illustrated in FIG. 2A, Pic₄ is illustrated as including two slices (i.e., Slice₁ and Slice₂) where each slice includes a sequence of CTUs (e.g., in raster scan order). In the example illustrated in FIG. 2B, Pic₄ is illustrated as including six tiles (i.e., Tile₁ to Tile₆), where each tile is rectangular and includes a sequence of CTUs. It should be noted that in ITU-T H.265, a tile may consist of coding tree units contained in more than one slice and a slice may consist of coding tree units contained in more than one tile. However, ITU-T H.265 provides that one or both of the following conditions shall be fulfilled: (1) All coding tree units in a slice belong to the same tile; and (2) All coding tree units in a tile belong to the same slice. Thus, with respect to FIG. 2B, each of the tiles may belong to a respective slice (e.g., Tile₁ to Tile₆ may respectively belong to slices, Slice₁ to Slice₆) or multiple tiles may belong to a slice (e.g., Tile₁ to Tile₃ may belong to Slice₁ and Tile₄ to Tile₆ may belong to Slice₂).

Further, as illustrated in FIG. 2B, tiles may form tile sets (i.e., Tile₂ and Tile₅ form a tile set). Tile sets may be used to define boundaries for coding dependencies (e.g., intra-prediction dependencies, entropy encoding dependencies, etc.) and as such, may enable parallelism in coding and region-of-interest coding. For example, if the video sequence in the example illustrated in FIG. 2B corresponds to a nightly news program, the tile set formed by Tile₂ and Tile₅ may correspond to a visual region-of-interest including a news anchor reading the news. ITU-T H.265 defines signaling that enables motion-constrained tile sets (MCTS). A motion-constrained tile set may include a tile set for which inter-picture prediction dependencies are limited to the collocated tile sets in reference pictures. Thus, it is possible to perform motion compensation for a given MCTS independent of the decoding of other tile sets outside the MCTS. For example, referring to FIG. 2B, if the tile set formed by Tile₂ and Tile₅ is a MCTS and each of Pic₁ to Pic₃ include collocated tile sets, motion compensation may be performed on Tile₂ and Tile₅ independent of coding Tile₁, Tile₃, Tile₄, and Tile₆ in Pic₄ and tiles collocated with tiles Tile₁, Tile₃, Tile₄, and Tile₆ in each of Pic₁ to Pic₃. Coding video data according to MCTS may be useful for video applications including omnidirectional video presentations.

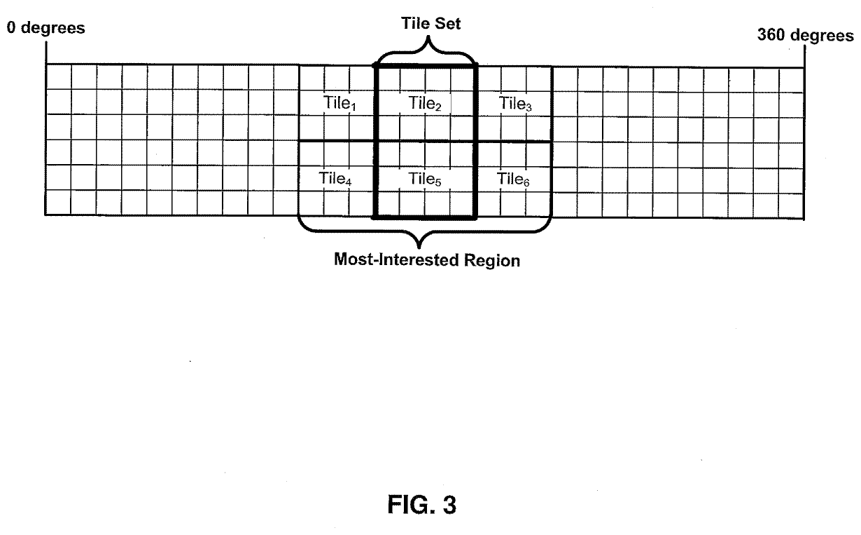

As illustrated in FIG. 3, tiles (i.e., Tile₁ to Tile₆) may form a most-interested region of an omnidirectional video. Further, the tile set formed by Tile₂ and Tile₅ may be a MCTS included within the most-interested region. Viewport dependent video coding, which may also be referred to as viewport dependent partial video coding, may be used to enable coding of only part of an entire video region. That is, for example, view port dependent video coding may be used to provide sufficient information for rendering of a current FOV. For example, omnidirectional video may be coded using MCTS, such that each potential region covering a viewport can be independently coded from other regions across time. In this case, for example, for a particular current viewport, a minimum set of tiles that cover a viewport may be sent to the client, decoded, and/or rendered. This process may be referred to as simple tile based partial decoding (STPD).

As described above, Choi specifies a list of projection techniques that can be used for conversion of a spherical or 360 degree video into a two-dimensional rectangular video. Choi specifies where a projected frame is a frame that has a representation format by a 360 degree video projection indicator and where a projection is the process by which a set of input images are projected onto a projected frame. Further, Choi specifies where a projection structure includes a three-dimensional structure including one or more surfaces on which the captured image/video content is projected, and from which a respective projected frame can be formed. Finally, Choi provides where a region-wise packing includes a region-wise transformation, resizing, and relocating of a projected frame and where a packed frame is a frame that results from region-wise packing of a projected frame. Thus, in Choi, the process for creating 360 degree spherical video may be described as including image stitching, projection, and region-wise packing. It should be noted that Choi specifies a coordinate system, omnidirectional projection formats, including an equirectangular projection, a rectangular region-wise packing format, and an omnidirectional fisheye video format, for the sake of brevity, a complete description of all of these sections of Choi is not provided herein. However, reference is made to the relevant sections of Choi.

It should be noted that in Choi, if region-wise packing is not applied, the packed frame is identical to the projected frame. Otherwise, regions of the projected frame are mapped onto a packed frame by indicating the location, shape, and size of each region in the packed frame. Further, in Choi, in the case of stereoscopic 360 degree video, the input images of one time instance are stitched to generate a projected frame representing two views, one for each eye. Both views can be mapped onto the same packed frame and encoded by a traditional two-dimensional video encoder. Alternatively, Choi provides, where each view of the projected frame can be mapped to its own packed frame, in which case the image stitching, projection, and region-wise packing is similar to the monoscopic case described above. Further, in Choi, a sequence of packed frames of either the left view or the right view can be independently coded or, when using a multiview video encoder, predicted from the other view. Finally, it should be noted that in Choi, the image stitching, projection, and region-wise packing process can be carried out multiple times for the same source images to create different versions of the same content, e.g. for different orientations of the projection structure and similarly, the region-wise packing process can be performed multiple times from the same projected frame to create more than one sequence of packed frames to be encoded.

Choi specifies a file format that generally supports the following types of metadata: (1) metadata specifying the projection format of the projected frame; (2) metadata specifying the area of the spherical surface covered by the projected frame; (3) metadata specifying the orientation of the projection structure corresponding to the projected frame in a global coordinate system; (4) metadata specifying region-wise packing information; and (5) metadata specifying optional region-wise quality ranking

It should be noted that with respect to the equations used herein, the following arithmetic operators may be used:
+ Addition
− Subtraction (as a two-argument operator) or negation (as a unary prefix operator)
* Multiplication, including matrix multiplication
x^{y} Exponentiation. Specifics x to the power of y. In other contexts, such notation is used for superscripting not intended for interpretation as exponentiation.
/ Integer division with truncation of the result toward zero. For example, 7/4 and −7/−4 are truncated to 1 and −7/4 and 7/−4 are truncated to −1.
÷ Used to denote division in mathematical equations where no truncation or rounding is intended.

$$\frac{x}{y}$$

Used to denote division in mathematical equations where no truncation or rounding is intended.

It should be noted that with respect to the equations used herein, the following logical operators may be used:
x&&y Boolean logical “and” of x and y
x||y Boolean logical “or” of x and y
!Boolean logical “not”
x?y:z If x is TRUE or not equal to 0, evaluates to the value of y; otherwise, evaluates to the value of z.

It should be noted that with respect to the equations used herein, the following relational operators may be used:
> Greater than
>= Greater than or equal to
< Less than
<= Less than or equal to
== Equal to
!= Not equal to

With respect to omnidirectional projection formats, Choi provides the following for an equirectangular projection:
The samples of the projected frame at locations (i, j) correspond to angular coordinates (ϕ, θ) as specified in this clause. The angular coordinates (ϕ, θ) correspond to the yaw and pitch angles, respectively, in the coordinate system [where yaw rotates around the Y (vertical, up) axis, pitch around the X (lateral, side-to-side) axis, and roll around the Z (back-to-front) axis. Rotations are extrinsic, i.e., around the X, Y, and Z fixed reference axes. The angles increase counter-clockwise when looking towards the origin. Where the range of yaw is −180 degrees, inclusive, to 180 degrees, exclusive; the range of pitch is −90 degrees, inclusive, to 90 degrees, exclusive; and the range of roll is −180 degrees, inclusive, to 180 degrees, exclusive.]
When RegionWisePackingBox is absent, proj_frame_width and proj_frame_height are inferred to be equal to width and height of VisualSampleEntry.
When CoverageInformationBox is absent, hor_range is inferred to be equal to 36000 and ver_range is inferred to be equal to 18000.
The variables yawMin, yawMax, pitchMin, and pitchMax are derived as follows:
NOTE: The value ranges of the variables yawMin, yawMax, pitchMin, and pitchMax are not limited to that of the yaw and pitch angles as specified above.
yawMin=(center_yaw−hor_range÷2)*0.01*π÷180
yawMax=(center_yaw+hor_range÷2)*0.01*π÷180
pitchMin=(center_pitch−ver_range÷2)*0.01*π÷180
pitchMax=(center_pitch+ver_range÷2)*0.01*π÷180
For i equal to 0 to proj_frame_width−1, inclusive, and j equal to 0 to proj_frame_height−1, inclusive, the corresponding angular coordinates (ϕ, θ) for the luma sample locations, in radians, are given by the following equirectangular mapping equations
For the chroma format and chroma location type LocType in use, the values of CenterLeftOffsetC, CenterTopOffsetC, FrameWidthC, and FrameHeightC are specified in Table 1:

TABLE 1

| Chroma | | CenterLeft | CenterTop | | |
|---|---|---|---|---|---|
| format | LocType | OffsetC | OffsetC | FrameWidthC | FrameHeightC |
| 4:2:0 | 0 | 0.125 | 0.25 | proj_frame_width/2 | proj_frame_height/2 |
| 4:2:0 | 1 | 0.25 | 0.25 | proj_frame_width/2 | proj_frame_height/2 |
| 4:2:0 | 2 | 0.125 | 0.125 | proj_frame_width/2 | proj_frame_height/2 |
| 4:2:0 | 3 | 0.25 | 0.125 | proj_frame_width/2 | proj_frame_height/2 |
| 4:2:0 | 4 | 0.125 | 0.375 | proj_frame_width/2 | proj_frame_height/2 |
| 4:2:0 | 5 | 0.25 | 0.375 | proj_frame_width/2 | proj_frame_height/2 |
| 4:2:2 | — | 0.125 | 0.5 | proj_frame_width/2 | proj_frame_height/2 |
| 4:4:4 | — | 0.5 | 0.5 | proj_frame_width | proj_frame_height |

For i equal to 0 to FrameWidthC−1, inclusive, and j equal to 0 to FrameHeightC−1, inclusive, the corresponding angular coordinates (ϕ, θ) for the chroma sample locations, in radians, are given by the following equirectangular mapping equations:

ϕ=(i+CenterLeftOffsetC)*(yaw Max−yaw Min)÷FrameWidthC+yaw Min

θ=(j+CenterTopOffsetC)*(pitch Min−pitch Max)÷FrameHeightC−pitch Min

It should be noted that the equirectangular projection provided in Choi may be less than ideal.

With respect to region-wise packing, Choi provides the following definition, syntax, and semantics for a rectangular region-wise packing:

### Definition

RectRegionPacking(i) specifies how a source rectangular region of a projected frame is packed onto a destination rectangular region of a packed frame. Horizontal mirroring and rotation by 90, 180, or 270 degrees can be indicated, and vertical and horizontal resampling are inferred from the width and height of regions.

### Syntax

aligned(8) class RectRegionPacking(i) {

unsigned int(32) proj_reg_width[i];
unsigned int(32) proj_reg_height[i];
unsigned int(32) proj_reg_top[i];
unsigned int(32) proj_reg_left[i];
unsigned int(8) transform_type[i];
unsigned int(32) packed_reg_width[i];
unsigned int(32) packed_reg_height[i];
unsigned int(32) packed_reg_top[i];
unsigned int(32) packed_reg_left[i];

}

### Semantics

proj_reg_width[i], proj_reg_height[i], proj_reg_top[i] and proj_reg_left[i] are indicated in units of pixels in a projected frame with width and height equal to proj_frame_width and proj_frame_height, respectively.
proj_reg_width[i] specifies the width of the i-th region of the projected frame. proj_reg_width[i] shall be greater than 0.
proj_reg_height[i] specifies the height of the i-th region of the projected frame. proj_reg_height[i] shall be greater than 0.
proj_reg_top[i] and proj_reg_left[i] specify the top sample row and the left-most sample column in the projected frame. The values shall be in the range from 0, inclusive, indicating the top-left corner of the projected frame, to proj_frame_height and proj_frame_width, exclusive, respectively.
proj_reg_width[i] and proj_reg_left[i] shall be constrained such that proj_reg_width[i]+proj_reg_left[i] is less than proj_frame_width.
proj_reg_height[i] and proj_reg_top[i] shall be constrained such that proj_reg_height[i]+proj_reg_top[i] is less than proj_frame_height.
When the projected frame is stereoscopic, proj_reg_width[i], proj_reg_height[i], proj_reg_top[i] and proj_reg_left[i] shall be such that the region identified by these fields on the projected frame is within a single constituent frame of the projected frame.
transform_type[i] specifies the rotation and mirroring that has been applied to the i-th region of a projected frame to map it to the packed frame. When transform_type[i] specifies both rotation and mirroring, rotation is applied after mirroring. The following values are specified and other values are reserved:
   1: no transform
   2: mirroring horizontally
   3: rotation by 180 degrees (counter-clockwise)
   4: rotation by 180 degrees (counter-clockwise) after mirroring horizontally
   5: rotation by 90 degrees (counter-clockwise) after mirroring horizontally
   6: rotation by 90 degrees (counter-clockwise)
   7: rotation by 270 degrees (counter-clockwise) after mirroring horizontally
   8: rotation by 270 degrees (counter-clockwise)
packed_reg_width[i], packed_reg_height[i], packed_reg_top[i], and packed_reg_left[i] specify the width, height, the top sample row, and the left-most sample column, respectively, of the region in the packed frame. The rectangle specified by packed_reg_width[i], packed_reg_height[i], packed_reg_top[i], and packed_reg_left[i] shall be non-overlapping with the rectangle specified by packed_reg_width[j], packed_reg_height[j], packed_reg_top[j], and packed_reg_left[j] for any value of j in the range of 0 to i−1, inclusive.

It should be noted that the syntax for rectangular region-wise packing provided in Choi may be less than ideal. Further, it should be noted that in the syntax above and the syntax used herein, unsigned int(n) refers to an unsigned integer having n-bits.

As described above, Choi specifies how to store omnidirectional media and the associated metadata using the International Organization for Standardization (ISO) base media file format (ISOBMFF). Further, Choi specifies where the file format supports the following types of boxes: a scheme type box (SchemeTypeBox), a scheme information box (SchemeInformationBox), a projected omnidirectional video box (ProjectedOmnidirectionalVideoBox), a stereo video box (StereoVideoBox), a fisheye omnidirectional video box (FisheyeOmnidirectionalVideoBox), a region-wise packing box (RegionWisePackingBox), and a projection orientation box (ProjectionOrientationBox). It should be noted that Choi specifies additional types boxes, for the sake of brevity, a complete description of all the type of boxes specified in Choi are not described herein. With respect to SchemeTypeBox, SchemeInformationBox, ProjectedOmnidirectionalVideoBox, StereoVideoBox, and RegionWisePackingBox, Choi provides the following:
The use of the omnidirectional video scheme for the restricted video sample entry type ‘resv’ indicates that the decoded pictures are either fisheye video pictures or packed frames containing either monoscopic or stereoscopic content. The use of the omnidirectional video scheme is indicated by scheme_type equal to ‘odvd’ (omnidirectional video) within the SchemeTypeBox.
The format of the projected monoscopic frames is indicated with the ProjectedOmnidirectionalVideoBox contained within the SchemeInformationBox. The format of fisheye video is indicated with the FisheyeOmnidirectionalVideoBox contained within the SchemeInformationBox. One and only one of ProjectedOmnidirectionalVideoBox and FisheyeOmnidirectionalVideoBox shall be present in the SchemeInformationBox when the scheme type is ‘odvd’.
When the ProjectedOmnidirectionalVideoBox is present in the SchemeInformationBox, StereoVideoBox and RegionWisePackingBox may be present in the same SchemeInformationBox. When FisheyeOmnidirectionalVideoBox is present in the SchemeInformationBox, StereoVideoBox and RegionWisePackingBox shall not be present in the same SchemeInformationBox.
For stereoscopic video, the frame packing arrangement of the projected left and right frames is indicated with the StereoVideoBox contained within the SchemeInformationBox. The absence of StereoVideoBox indicates that the omnidirectionally projected content of the track is monoscopic. When StereoVideoBox is present in the SchemeInformationBox for the omnidirectional video scheme, it shall indicate either top-bottom frame packing or side-to-side frame packing.
Optional region-wise packing is indicated with the RegionWisePackingBox contained within the SchemeInformationBox. The absence of RegionWisePackingBox indicates that no region-wise packing is applied,

With respect to the Region-wise packing box, Choi provides the following definition, syntax, and semantics:

### Definition

Box Type: ‘rwpk’
Container: Scheme Information box (‘schi’)
Mandatory: No
Quantity: Zero or one
RegionWisePackingBox indicates that projected frames are packed region-wise and require unpacking prior to rendering.

### Syntax

aligned(8) class RegionWisePackingBox extends Box(‘rwpk’) {

RegionWisePackingStruct( );

}
aligned(8) class RegionWisePackingStruct {

unsigned int(8) num_regions;
unsigned int(32) proj_frame_width;
unsigned int(32) proj_frame_height;
for (i = 0; i < num_regions; i++) {

bit(4) reserved = 0;
unsigned int(4) packing_type[i];

}
for (i = 0; i < num_regions; i++) {

if (packing_type[i] == 0)

RectRegionPacking(i);

}

}

### Semantics

num_regions specifies the number of packed regions. Value 0 is reserved.
proj_frame_width and proj_frame_height specify the width and height, respectively, of the projected frame.
packing_type specifies the type of region-wise packing. packing_type equal to 0 indicates rectangular region-wise packing. Other values are reserved.

With respect to the projected omnidirectional video box, Choi provides the following definition, syntax and semantics:

### Definition

Box Type: ‘povd’
Container: Scheme Information box (‘schi’)
Mandatory: No
Quantity: Zero or one (when scheme_type is equal to ‘odvd’, either ‘povd’ or ‘fovd’ must be present)
ProjectedOmnidirectionalVideoBox is used to indicate that samples contained in the track are projected or packed frames.
The properties of the projected frames are indicated with the following:
   the projection format of a monoscopic projected frame (C for monoscopic video contained in the track, CL and CR for left and right view of stereoscopic video);
   the orientation of the projection structure relative to the global coordinate system; and
   the spherical coverage of the projected omnidirectional video (i.e., the area on the spherical surface that is represented by the projected frame).

### Syntax

aligned(8) class ProjectedOmnidirectionalVideoBox extends
Box(‘povd’) {

ProjectionFormatBox( ); // mandatory
ProjectionOrientationBox( ); // optional
CoverageInformationBox( ); // optional

}
aligned(8) class ProjectionFormatBox( ) extends FullBox(‘prfr’, 0, 0) {

ProjectionFormatStruct( );

}
aligned(8) class ProjectionFormatStruct( ) {

bit(1) reserved = 0;
unsigned int(6) geometry_type;
bit(1) reserved = 0;
unsigned int(8) projection_type;

}

### Semantics

geometry_type indicates the mathematical convention where points within a space can be uniquely identified by a location in one or more dimensions. When geometry_type is equal to 1, the projection indicator is given in spherical coordinates, where ϕ is the azimuth (longitude) or the YawAngle and θ is the elevation (latitude) or the PitchAngle, according to the specified coordinate system. Other values of geometry_type are reserved.
projection_type indicates the particular mapping of the rectangular decoder picture output samples onto the coordinate system specified by geometry_type. When projection_type is equal to 1, geometry_type shall be equal to 1. projection_type equal to 1 indicates the a specified equirectangular projection. Other values of projection_type are reserved.

With respect to the Projection orientation box, Choi provides the following definition, syntax, and semantics:

### Definition

Box Type: ‘pror’
Container: Projected omnidirectional video box (‘povd’)
Mandatory: No
Quantity: Zero or one
When the projection format is the equirectangular projection, the fields in this box provides the yaw, pitch, and roll angles, respectively, of the center point of the projected frame when projected to the spherical surface. In the case of stereoscopic omnidirectional video, the fields apply to each view individually rather than the frame-packed stereoscopic frame. When the ProjectionOrientationBox is not present, the fields orientation_yaw, orientation_pitch, and orientation_roll are all considered to be equal to 0.

### Syntax

aligned(8) class ProjectionOrientationBox extends FullBox(‘pror’,
version = 0, flags) {

signed int(16) orientation_yaw;
signed int(16) orientation_pitch;
signed int(16) orientation_roll;

}

### Semantics

orientation_yaw, orientation_pitch, and orientation_roll specify the yaw, pitch, and roll of the projection in units of 0.01 degrees relative to the global coordinate system. orientation_yaw shall be in the range of −18000 to 17999, inclusive. orientation_pitch shall be in the range of −9000 to 9000, inclusive. orientation_roll shall be in the range of −18000 to 18000, inclusive.

Further, with respect to a coverage information box, Choi provides the following definition, syntax, and semantics:

### Definition

Box Type: ‘covi’
Container: Projected omnidirectional video box (‘povd’)
Mandatory: No
Quantity: Zero or one
This box provides information on the area on the spherical surface that is represented by the projected frame associated with the container ProjectedOmnidirectionalVideoBox. The absence of this box indicates that the projected frame is a representation of the full sphere. The fields in this box apply after the application of the ProjectionOrientationBox, when present.
When the projection format is the equirectangular projection, the spherical region represented by the projected frame is the region specified by two yaw circles and two pitch circles.

### Syntax

aligned(8) class CoverageInformationBox extends FullBox(‘covi’,
version = 0, flags) {

RegionOnSphereStruct(1);

}

### Semantics

When RegionOnSphereStruct(1) is included in the CoverageInformationBox, the following applies:
center_yaw and center_pitch specify the center point of the spherical region represented by the projected frame, in units of 0.01 degrees, relative to the coordinate system specified through the ProjectionOrientationBox. center_yaw shall be in the range of −18000 to 17999, inclusive. center_pitch shall be in the range of −9000 to 9000, inclusive.
hor_range and ver_range specify the horizontal and vertical range, respectively, of the region represented by the projected frame, in units of 0.01 degrees. hor_range and ver_range specify the range through the center point of the region. hor_range shall be in the range of 1 to 36000, inclusive. ver_range shall be in the range of 1 to 18000, inclusive. center_pitch+ver_range÷2 shall not be greater than 9000. center_pitch−ver_range÷2 shall not be less than −9000.

It should be noted that the Equirectangular projection, Region-wise packing box, the Projection orientation box, and the Coverage information box provided in Choi may be less than ideal.

As described above, signaling most-interested regions in an omnidirectional video picture may improve system performance by lowering transmission bandwidth and lowering decoding complexity. Choi provides the following syntax and semantics for signaling most-interested regions:

### Syntax

unsigned int(32) regionbase_id;
unsigned int(16) entry_count;
for (i=1; i<= entry_count; i++) {

unsigned int(16) left_horizontal_offset;
unsigned int(16) top_vertical_offset;
unsigned int(16) region_width;
unsigned int(16) region_height;

}

### Semantics

regionbase_id specifies the base region against which the positions and sizes of the most-interested regions are specified.
entry_count specifies the number of entries.
left_horizontal_offset, top_vertical_offset, region_width, and region_height are integer values that indicate the position and size of the most-interested region. left_horizontal_offset and top_vertical_offset indicate the horizontal and vertical coordinates, respectively, in luma samples, of the upper left corner of the most-interested region in relative to the base region. region_width and region_height indicate the width and height, respectively, in luma samples, of the most-interested region in relative to the base region.

It should be noted that signaling a most interested region as provided in Choi may be less than ideal.

As described above, Choi specifies techniques for streaming omnidirectional media. In this manner, Choi provides a generic timed metadata track syntax for indicating regions on a sphere, which may be useful for streaming omnidirectional media. The purpose for a timed metadata track in Choi is indicated by the sample entry type and the sample format of all metadata tracks starts with a common part and may be followed by an extension part that is specific to the sample entry of the metadata track.

Further, each sample specifies a region on a sphere. Choi provides the following definition, syntax, and semantics for a timed metadata track sample entry:

### Definition

Exactly one RegionOnSphereConfigBox shall be present in the sample entry. RegionOnSphereConfigBox specifies the shape of the region specified by the samples. When the horizontal and vertical ranges of the region in the samples do not change, they can be indicated in the sample entry.

### Syntax

class RegionOnSphereSampleEntry extends
MetaDataSampleEntry(‘rosp’) {

RegionOnSphereConfigBox( ); // mandatory
Box[ ] other_boxes; // optional

}
class RegionOnSphereConfigBox extends FullBox(‘rosc’, version = 0,
flags) {

unsigned int(8) shape_type;
bit(7) reserved = 0;
unsigned int(1) dynamic_range_flag;
if (dynamic_range_flag == 0) {

unsigned int(16) static_hor_range;
unsigned int(16) static_ver_range;

}
unsigned int(16) num_regions;

### Semantics

shape_type equal to 0 specifies that the region is specified by four great circles.
shape_type equal to 1 specifies that the region is specified by two yaw circles and two pitch circles.
shape_type values greater than 1 are reserved.
dynamic_range_flag equal to 0 specifies that the horizontal and vertical ranges of the region remain unchanged in all samples referring to this sample entry. dynamic_range_flag equal to 1 specifies that the horizontal and vertical ranges of the region is indicated in the sample format.
static_hor_range and static_ver_range specify the horizontal and vertical ranges, respectively, of the region for each sample referring to this sample entry in units of 0.01 degrees. static_hor_range and static_ver_range specify the ranges through the center point of the region.
num_regions specifies the number of regions in the samples referring to this sample entry. num_regions shall be equal to 1. Other values of num_regions are reserved.

Choi provides the following definition, syntax, and semantics for the sample format:

### Definition

Each sample specifies a region on a sphere. The RegionOnSphereSample structure may be extended in derived track formats.

### Syntax

aligned(8) RegionOnSphereStruct(range_included_flag) {

signed int(16) center_yaw;
signed int(16) center_pitch;
if (range_included_flag) {

unsigned int(16) hor_range;
unsigned int(16) ver_range;

}
aligned(8) RegionOnSphereSample( ) {

for (i = 0; i < num_regions; i++)

RegionOnSphereStruct(dynamic_range_flag)

}

### Semantics

When RegionOnSphereStruct( ) is included in the RegionOnSphereSample( )structure, the following applies:
center_yaw and center_pitch specify the center point of the region specified by this sample in units of 0.01 degrees relative to the global coordinate system. center_yaw shall be in the range of −18000 to 17999, inclusive. center_pitch shall be in the range of −9000 to 9000, inclusive.
hor_range and ver_range, when present, specify the horizontal and vertical ranges, respectively, of the region specified by this sample in units of 0.01 degrees, hor_range and ver_range specify the range through the center point of the region.

Further, Choi provides the following definition, syntax, and semantics for an initial viewpoint:

### Definition

The initial viewpoint region-on-sphere metadata indicates initial viewport orientations that should be used when playing the associated media tracks. In the absence of this type of metadata the playback should be started using the orientation (0, 0, 0) in (yaw, pitch, roll) of the global coordinate system.
The sample entry type ‘invp’ shall be used.
shape_type shall be equal to 0, dynamic_range_flag shall be equal to 0, static_hor_range shall be equal to 0, and static_ver_range shall be equal to 0 in the RegionOnSphereConfigBox of the sample entry.

### Syntax

class InitialViewpointSample( ) extends RegionOnSphereSample {

unsigned int(16) roll;
unsigned int(1) refresh_flag;
bit(7) reserved = 0;

}

### Semantics

NOTE 1: As the sample structure extends from RegionOnSphereSample, the syntax elements of RegionOnSphereSample are included in the sample.
center_yaw, center_pitch, and roll specify the viewport orientation in units of 0.01 degrees relative to the global coordinate system. center_yaw and center_pitch indicate the center of the viewport, and roll indicates the roll angle of the viewport. roll shall be in the range of −18000 to 18000, inclusive.
refresh_flag equal to 0 specifies that the indicated viewport orientation should be used when starting the playback from a time-parallel sample in an associated media track. refresh_flag equal to 1 specifies that the indicated viewport orientation should always be used when rendering the time-parallel sample of each associated media track, i.e. both in continuous playback and when starting the playback from the time-parallel sample.
NOTE 2: refresh_flag equal to 1 enables the content author to indicate that a particular viewport orientation is recommended even when playing the video continuously. For example, refresh_flag equal to 1 can be indicated for a scene cut position.

Further, Choi provides the following description for a recommended viewport:
The recommended viewport timed metadata track indicates the viewport that should be displayed when the user does not have control of the viewing orientation or has released control of the viewing orientation.
NOTE: The recommended viewport timed metadata track may be used for indicating a director's cut.
The sample entry type ‘rcvp’ shall be used.
The sample syntax of RegionOnSphereSample shall be used.
shape_type shall be equal to 0 in the RegionOnSphereConfigBox of the sample entry.
static_hor_range and static_ver_range, when present, or hor_range and ver_range, when present, indicate the horizontal and vertical fields of view, respectively, of the recommended viewport.
center_yaw and center_pitch indicate the center point of the recommended viewport.

It should be noted that signaling timed metadata for regions on sphere as provided in Choi may be less than ideal. Additionally, as described above, the Equirectangular projection, the Projection orientation box, and the Coverage information box provided in Choi may be less than ideal. In particular, in one case, the precision and techniques used to signal angle values may be less than ideal.

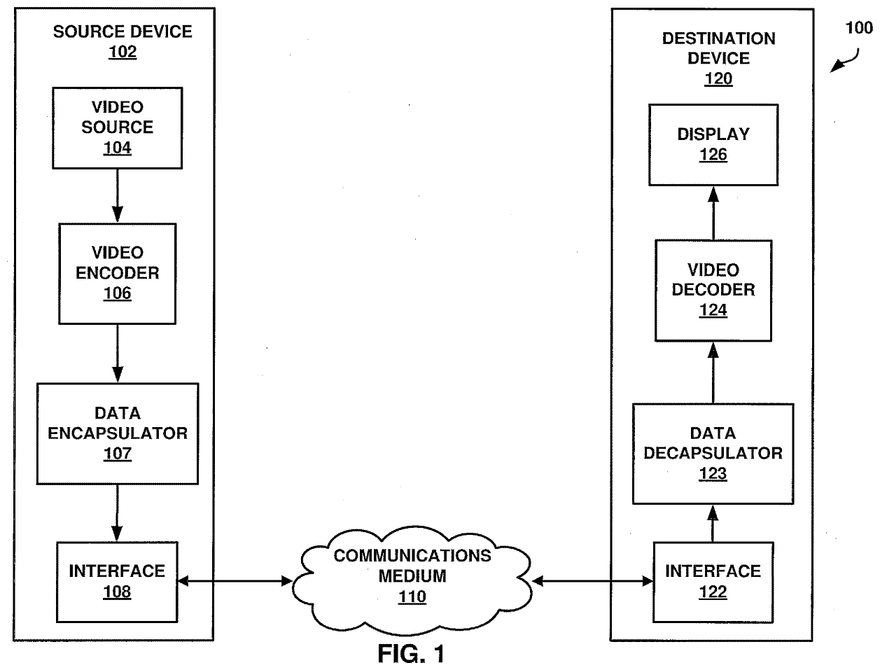

FIG. 1 is a block diagram illustrating an example of a system that may be configured to code (i.e., encode and/or decode) video data according to one or more techniques of this disclosure. System 100 represents an example of a system that may encapsulate video data according to one or more techniques of this disclosure. As illustrated in FIG. 1, system 100 includes source device 102, communications medium 110, and destination device 120. In the example illustrated in FIG. 1, source device 102 may include any device configured to encode video data and transmit encoded video data to communications medium 110. Destination device 120 may include any device configured to receive encoded video data via communications medium 110 and to decode encoded video data. Source device 102 and/or destination device 120 may include computing devices equipped for wired and/or wireless communications and may include, for example, set top boxes, digital video recorders, televisions, desktop, laptop or tablet computers, gaming consoles, medical imagining devices, and mobile devices, including, for example, smartphones, cellular telephones, personal gaming devices.

Communications medium 110 may include any combination of wireless and wired communication media, and/or storage devices. Communications medium 110 may include coaxial cables, fiber optic cables, twisted pair cables, wireless transmitters and receivers, routers, switches, repeaters, base stations, or any other equipment that may be useful to facilitate communications between various devices and sites. Communications medium 110 may include one or more networks. For example, communications medium 110 may include a network configured to enable access to the World Wide Web, for example, the Internet. A network may operate according to a combination of one or more telecommunication protocols. Telecommunications protocols may include proprietary aspects and/or may include standardized telecommunication protocols. Examples of standardized telecommunications protocols include Digital Video Broadcasting (DVB) standards, Advanced Television Systems Committee (ATSC) standards, Integrated Services Digital Broadcasting (ISDB) standards, Data Over Cable Service Interface Specification (DOCSIS) standards, Global System Mobile Communications (GSM) standards, code division multiple access (CDMA) standards, 3rd Generation Partnership Project (3GPP) standards, European Telecommunications Standards Institute (ETSI) standards, Internet Protocol (IP) standards, Wireless Application Protocol (WAP) standards, and Institute of Electrical and Electronics Engineers (IEEE) standards.

Storage devices may include any type of device or storage medium capable of storing data. A storage medium may include a tangible or non-transitory computer-readable media. A computer readable medium may include optical discs, flash memory, magnetic memory, or any other suitable digital storage media. In some examples, a memory device or portions thereof may be described as non-volatile memory and in other examples portions of memory devices may be described as volatile memory. Examples of volatile memories may include random access memories (RAM), dynamic random access memories (DRAM), and static random access memories (SRAM). Examples of non-volatile memories may include magnetic hard discs, optical discs, floppy discs, flash memories, or forms of electrically programmable memories (EPROM) or electrically erasable and programmable (EEPROM) memories. Storage device(s) may include memory cards (e.g., a Secure Digital (SD) memory card), internal/external hard disk drives, and/or internal/external solid state drives. Data may be stored on a storage device according to a defined file format.

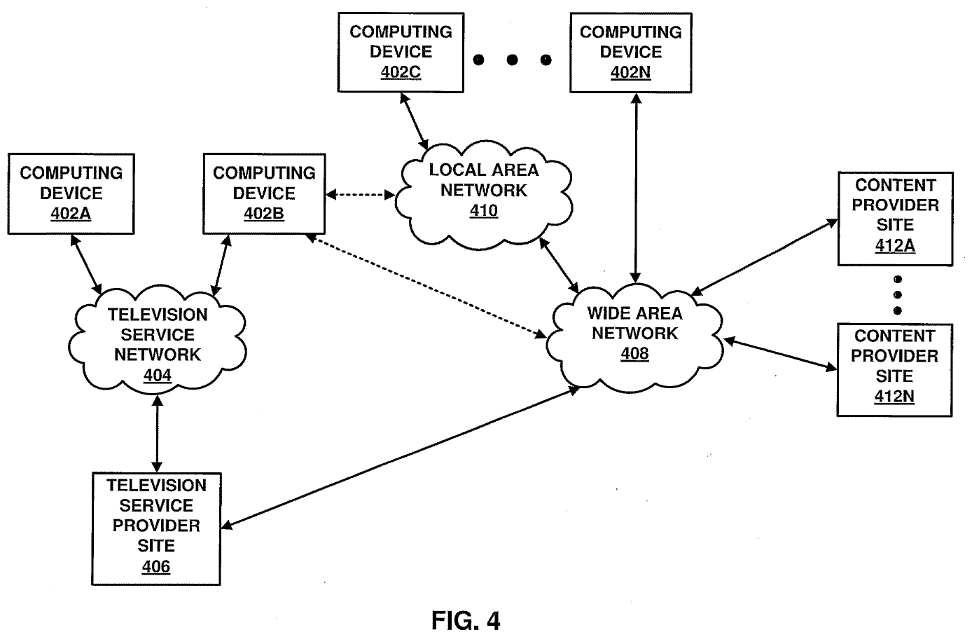

FIG. 4 is a conceptual drawing illustrating an example of components that may be included in an implementation of system 100. In the example implementation illustrated in FIG. 4, system 100 includes one or more computing devices 402A-402N, television service network 404, television service provider site 406, wide area network 408, local area network 410, and one or more content provider sites 412A-412N. The implementation illustrated in FIG. 4 represents an example of a system that may be configured to allow digital media content, such as, for example, a movie, a live sporting event, etc., and data and applications and media presentations associated therewith to be distributed to and accessed by a plurality of computing devices, such as computing devices 402A-402N. In the example illustrated in FIG. 4, computing devices 402A-402N may include any device configured to receive data from one or more of television service network 404, wide area network 408, and/or local area network 410. For example, computing devices 402A-402N may be equipped for wired and/or wireless communications and may be configured to receive services through one or more data channels and may include televisions, including so-called smart televisions, set top boxes, and digital video recorders. Further, computing devices 402A-402N may include desktop, laptop, or tablet computers, gaming consoles, mobile devices, including, for example, “smart” phones, cellular telephones, and personal gaming devices.

Television service network 404 is an example of a network configured to enable digital media content, which may include television services, to be distributed. For example, television service network 404 may include public over-the-air television networks, public or subscription-based satellite television service provider networks, and public or subscription-based cable television provider networks and/or over the top or Internet service providers. It should be noted that although in some examples television service network 404 may primarily be used to enable television services to be provided, television service network 404 may also enable other types of data and services to be provided according to any combination of the telecommunication protocols described herein. Further, it should be noted that in some examples, television service network 404 may enable two-way communications between television service provider site 406 and one or more of computing devices 402A-402N. Television service network 404 may comprise any combination of wireless and/or wired communication media. Television service network 404 may include coaxial cables, fiber optic cables, twisted pair cables, wireless transmitters and receivers, routers, switches, repeaters, base stations, or any other equipment that may be useful to facilitate communications between various devices and sites. Television service network 404 may operate according to a combination of one or more telecommunication protocols. Telecommunications protocols may include proprietary aspects and/or may include standardized telecommunication protocols. Examples of standardized telecommunications protocols include DVB standards, ATSC standards, ISDB standards, DTMB standards, DMB standards, Data Over Cable Service Interface Specification (DOCSIS) standards, HbbTV standards, W3C standards, and UPnP standards.

Referring again to FIG. 4, television service provider site 406 may be configured to distribute television service via television service network 404. For example, television service provider site 406 may include one or more broadcast stations, a cable television provider, or a satellite television provider, or an Internet-based television provider. For example, television service provider site 406 may be configured to receive a transmission including television programming through a satellite uplink/downlink Further, as illustrated in FIG. 4, television service provider site 406 may be in communication with wide area network 408 and may be configured to receive data from content provider sites 412A-412N. It should be noted that in some examples, television service provider site 406 may include a television studio and content may originate therefrom.

Wide area network 408 may include a packet based network and operate according to a combination of one or more telecommunication protocols. Telecommunications protocols may include proprietary aspects and/or may include standardized telecommunication protocols. Examples of standardized telecommunications protocols include Global System Mobile Communications (GSM) standards, code division multiple access (CDMA) standards, 3^{rd} Generation Partnership Project (3GPP) standards, European Telecommunications Standards Institute (ETSI) standards, European standards (EN), IP standards, Wireless Application Protocol (WAP) standards, and Institute of Electrical and Electronics Engineers (IEEE) standards, such as, for example, one or more of the IEEE 802 standards (e.g., Wi-Fi). Wide area network 408 may comprise any combination of wireless and/or wired communication media. Wide area network 480 may include coaxial cables, fiber optic cables, twisted pair cables, Ethernet cables, wireless transmitters and receivers, routers, switches, repeaters, base stations, or any other equipment that may be useful to facilitate communications between various devices and sites. In one example, wide area network 408 may include the Internet. Local area network 410 may include a packet based network and operate according to a combination of one or more telecommunication protocols. Local area network 410 may be distinguished from wide area network 408 based on levels of access and/or physical infrastructure. For example, local area network 410 may include a secure home network.

Referring again to FIG. 4, content provider sites 412A-412N represent examples of sites that may provide multimedia content to television service provider site 406 and/or computing devices 402A-402N. For example, a content provider site may include a studio having one or more studio content servers configured to provide multimedia files and/or streams to television service provider site 406. In one example, content provider sites 412A-412N may be configured to provide multimedia content using the IP suite. For example, a content provider site may be configured to provide multimedia content to a receiver device according to Real Time Streaming Protocol (RTSP), HTTP, or the like. Further, content provider sites 412A-412N may be configured to provide data, including hypertext based content, and the like, to one or more of receiver devices computing devices 402A-402N and/or television service provider site 406 through wide area network 408. Content provider sites 412A-412N may include one or more web servers. Data provided by data provider site 412A-412N may be defined according to data formats.

Referring again to FIG. 1, source device 102 includes video source 104, video encoder 106, data encapsulator 107, and interface 108. Video source 104 may include any device configured to capture and/or store video data. For example, video source 104 may include a video camera and a storage device operably coupled thereto. Video encoder 106 may include any device configured to receive video data and generate a compliant bitstream representing the video data. A compliant bitstream may refer to a bitstream that a video decoder can receive and reproduce video data therefrom. Aspects of a compliant bitstream may be defined according to a video coding standard. When generating a compliant bitstream video encoder 106 may compress video data. Compression may be lossy (discernible or indiscernible to a viewer) or lossless.

Referring again to FIG. 1, data encapsulator 107 may receive encoded video data and generate a compliant bitstream, e.g., a sequence of NAL units according to a defined data structure. A device receiving a compliant bitstream can reproduce video data therefrom. It should be noted that the term conforming bitstream may be used in place of the term compliant bitstream. As described above, the signaling of a metadata as provided in Choi may be less than ideal. In one example, data encapsulator 107 may be configured to signal metadata according to one or more techniques described herein. It should be noted that data encapsulator 107 need not necessary be located in the same physical device as video encoder 106. For example, functions described as being performed by video encoder 106 and data encapsulator 107 may be distributed among devices illustrated in FIG. 4.

Referring to the Equirectangular projection description in Choi described above, in one example, data encapsulator 107 may be configured to derive the variables yawMin, yawMax, pitchMin, and pitchMax according to the following example conditions and equations:

When RegionWisePackingBox is absent, proj_frame_width and proj_frame_height are inferred to be equal to width and height of VisualSampleEntry.

When CoverageInformationBox is absent, hor_range is inferred to be equal to 720*65536 and ver_range is inferred to be equal to 360*65536.
yawMin=(((center_yaw−hor_range÷2)<−18000)?(center_yaw−hor_range÷2+36000): (center_yaw−hor_range÷2))*0.01*π÷180
yawMax=(((center_yaw+hor_range÷2)>17999)?(center_yaw+hor_range÷2−36000): (center_yaw+hor_range÷2))*0.01*π÷180
pitchMin=(((center_pitch−ver_range÷2)<−9000)?(center_pitch−ver_range÷2+18000): (center_pitch−ver_range÷2))*0.01*π÷180
pitchMax=(((center_pitch+ver_range÷2)>9000)?(center_pitch+ver_range÷2−18000): (center_pitch+ver_range÷2))*0.01*π÷180
If binary angle measurement with 16 bits is used:
yawMin=(center_yaw−hor_range÷2)*(1÷65536)*π÷180
yawMax=(center_yaw+hor_range÷2)*(1÷65536)*π÷180
pitchMin=(center_pitch−ver_range÷2)*(1÷65536)*π÷180
pitchMax=(center_pitch+ver_range÷2)*(1÷65536)*π÷180
If 16.16 fixed point representation is used:
yawMin=(center_yaw−hor_range÷2)*(360÷4294967296)*π÷180
yawMax=(center_yaw+hor_range÷2)*(360÷4294967296)*π÷180
pitchMin=(center_pitch−ver_range÷2)*(180÷4294967296)*π÷180
pitchMax=(center_pitch+ver_range÷2)*(180÷4294967296)*π÷180

Thus, according to the techniques described herein, data encapsulator 107 may be configured to enable enhanced precision for angular values.

Referring to the RectRegionPacking(i) syntax provided in Choi described above, in one example, data encapsulator 107 may be configured to more efficiently signal RectRegionPacking(i). In one example, data encapsulator 107 may be configured to signal RectRegionPacking(i) according to the following syntax:

aligned(8) class RectRegionPacking[i] {

unsigned int(16) proj_reg_width[i];
unsigned int(16) proj_reg_height[i];
unsigned int(16) proj_reg_top[i];
unsigned int(16) proj_reg_left[i];
unsigned int(3) transform_type[i];
bit(5) reserved = 0;
unsigned int(16) packed_reg_width[i];
unsigned int(16) packed_reg_height[i];
unsigned int(16) packed_reg_top[i];
unsigned int(16) packed_reg_left[i];

}

In this example, the semantics of transform_type[i] may signal one of the eight transform types using 3 bits and may have the semantics:

transform_type[i] specifies the rotation and mirroring that has been applied to the i-th region of a projected frame to map it to the packed frame. When transform_type[i] specifies both rotation and mirroring, rotation is applied after mirroring. The following values are specified:
1: no transform
2: mirroring horizontally
3: rotation by 180 degrees (counter-clockwise)
4: rotation by 180 degrees (counter-clockwise) after mirroring horizontally
5: rotation by 90 degrees (counter-clockwise) after mirroring horizontally
6: rotation by 90 degrees (counter-clockwise)
7: rotation by 270 degrees (counter-clockwise) after mirroring horizontally
0: rotation by 270 degrees (counter-clockwise)

It should be noted that compared to Choi the value of 0 for transform_type[i] is used for indicating rotation by 270 degrees (counter-clockwise) and no values are kept reserved. Further, each of the other syntax elements are signaled using 16 bits, which results in a significant bit saving compared to RectRegionPacking(i) provided in Choi.

Referring to the RegionWisePackingBox syntax provided in Choi described above, in one example, data encapsulator 107 may be configured to more efficiently signal RegionWisePackingBox. In one example, data encapsulator 107 may be configured to signal RegionWisePackingBox where each of syntax elements proj_frame_width and proj_frame_height are signaled using 16 bits as shown in the following syntax:

aligned(8) class RegionWisePackingBox extends Box(‘rwpk’) {

RegionWisePackingStruct( );

}
aligned(8) class RegionWisePackingStruct {

unsigned int(8) num_regions;
unsigned int(16) proj_frame_width;
unsigned int(16) proj_frame_height;
for (i = 0; i < num_regions; i++) {

bit(4) reserved = 0;
unsigned int(4) packing_type[i];

}
for (i = 0; i < num_regions; i++) {

if (packing_type[i] = 0)

RectRegionPacking(i);

}

}

Further, in one example, syntax elements proj_frame_width and proj_frame_height may be constrained such that proj_frame_width shall not be equal to 0 and proj_frame_height shall not be equal to 0. That is, proj_frame_width shall be greater than zero and proj_frame_height shall be greater than zero. In one example, syntax elements proj_frame_width and proj_frame_height may use minus one signaling. That, is their value plus one may respectively indicate the width and the height of the projected frame. Further, in one example, data encapsulator 107 may be configured to signal RegionWisePackingBox where the num_regions uses minus one signaling. In this case, the following example semantics may be utilized:

For each value of i in the range of 0 to num_regions-1 the rectangle specified by packed_reg_width[i], packed_reg_height[i], packed_reg_top[i], and packed_reg_left[i] shall be non-overlapping with the rectangle specified by packed_reg_width[j], packed_reg_height[j], packed_reg_top[j], and packed_reg_left[j] for any value of j in the range of 0 to i−1, inclusive.

The union of the rectangles specified by packed_reg_width[i], packed_reg_height[i], packed_reg_top[i], and packed_reg_left[i] for all values of i in the range of 0 to num_regions-1 shall cover the entire projected frame specified by rectangle specified by top-left (x,y) co-ordinates (0, 0) and width and height respectively equal to proj_frame_width and proj_frame_height.

It should be noted that in Choi, Pitch values (e.g. orientation_pitch in ProjectionOrientationBox and center_pitch in RegionOnSphereStruct) are specified in units of 0.01 degree with a valid range of −9000 to 9000, inclusive. Thus, the allowed range of pitch values only needs 15 bits. Instead 16 bits are used for orientation_pitch and center_pitch. In one example, 15 bits may be used for orientation_pitch and center_pitch and the save 1-bits may be reserved for future use. The proposed changes are shown below. Referring to the ProjectionOrientationBox syntax provided in Choi described above, in one example, data encapsulator 107 may be configured to more efficiently signal ProjectionOrientationBox. In one example, data encapsulator 107 may be configured to signal ProjectionOrientationBox according to the following syntax:

aligned(8) class ProjectionOrientationBox extends FullBox(‘pror’,
version = 0, flags) {
signed int(16) orientation_yaw;
signed int(15) orientation_pitch;
bit(1) reserved = 0;

signed int(16) orientation_roll;

}

Further, in one example, data encapsulator 107 may be configured to signal ProjectionOrientationBox according to the following syntax and semantics:

### Syntax

aligned(8) class ProjectionOrientationBox extends FullBox(‘pror’,
version = 0, flags) {

signed int(32) orientation_yaw;
signed int(32) orientation_pitch;
signed int(32) orientation_roll;
}

### Semantics

orientation_yaw, orientation_pitch, and orientation_roll specify the yaw, pitch, and roll of the projection in units of 2⁻¹⁶ degrees, respectively relative to the global coordinate system. orientation_yaw shall be in the range of −180*2⁻¹⁶ to (180*2¹⁶)−1, inclusive. orientation_pitch shall be in the range of −90*2¹⁶ to 90*2¹⁶, inclusive, orientation_roll shall be in the range of −180*2¹⁶ to (180*2¹⁶)−1, inclusive.

Further, with respect to a coverage information box, in one example data encapsulator may be configured to signal CoverageInformationBox according to the following semantics:

### Semantics

When RegionOnSphereStruct(1) is included in the CoverageInformationBox, the following applies:
center_yaw and center_pitch specify the center point of the spherical region represented by the projected frame, in units of 2⁻¹⁶ degrees, respectively, relative to the coordinate system specified through the ProjectionOrientationBox. center_yaw shall be in the range of −180*2⁻¹⁶ to (180*2¹⁶)−1, inclusive. center_pitch shall be in the range of −90*2⁻¹⁶ to 90*2¹⁶, inclusive.
hor_range and ver_range specify the horizontal and vertical range, respectively, of the region represented by the projected frame, in units of 360÷2³² and 180÷2³² degrees, respectively. hor_range and ver_range specify the range through the center point of the region. hor_range shall be in the range of 1 to 2³²−1, inclusive. ver_range shall be in the range of 1 to 2³²−1, inclusive.

Thus, according to the techniques described herein, data encapsulator 107 may be configured to enable enhanced precision for angular values.

Referring to the RegionOnSphereStruct syntax provided in Choi described above, in one example, data encapsulator 107 may be configured to more efficiently signal RegionOnSphereStruct. In one example, data encapsulator 107 may be configured to signal RegionOnSphereStruct according to the following syntax:

aligned(8) RegionOnSphereStruct(range_included_flag) {

signed int(16) center_yaw;
signed int(15) center_pitch;
bit(1) reserved = 0;
if (range_included_flag) {

unsigned int(16) hor_range;
unsigned int(16) ver_range;

}
aligned(8) RegionOnSphereSample( ) {

for (i = 0; i < num_regions; i++)

RegionOnSphereStruct(dynamic_range_flag)

Referring to the syntax and semantics for signaling most-interested regions provided in Choi described above, in one example, data encapsulator 107 may be configured to more efficiently signal most-interested regions. Currently, the most-interested region signaling in Choi does not include information to identify signaled most-interested region across timed metadata track. For example, if a most-interested region rectangle which corresponds to “Director's Cut” changes in time it is not possible to indicate this with the current syntax of Choi. According to the example techniques described herein, a region tag identifier is associated with a region to identify signaled most-interested region across timed metadata track. The example description below signals a region_tag_id for the most-interested region.

Further, the current syntax in Choi does not allow specifying a human-readable label for the most-interested region. For example, such labels may include “Director's Cut” or “Most commented region” or “Social media popular view” or the like. The description below efficiently signals a human-readable region_label for a most-interested region.

In one example, data encapsulator 107 may be configured to signal most-interested regions according to the following syntax:

aligned(8) class MirSample( ){

unsigned int(32) regionbase_id;
unsigned int(16) entry_count;
for (i=1; i<= entry_count; i++) {

unsigned int(32) left_horizontal_offset;
unsigned int(32) top_vertical_offset;
unsigned int(32) region_width;
unsigned int(32) region_height;
unsigned int(15) region_tag_id;
unsigned int(1) region_label_present_flag;
if (region_label_present_flag) {
string region_label;
}

}

}

In this case, the following example semantics may be utilized:

regionbase_id specifies the base region against which the positions and sizes of the most-interested regions are specified.

entry_count specifies the number of entries. entry_count shall be greater than 0. In another example this element may instead be signalled as entry_count_minus1 which plus 1 specifies the number of entries.

left_horizontal_offset, top_vertical_offset, region_width, and region_height are integer values that indicate the position and size of the most-interested region. left_horizontal_offset and top_vertical_offset indicate the horizontal and vertical coordinates, respectively, in luma samples, of the upper left corner of the most-interested region in relative to the base region. region_width and region_height indicate the width and height, respectively, in luma samples, of the most-interested region in relative to the base region.

region_tag_id specifies an identifier which identifies this region within the base region and associates it with region_label. A region with a particular region_tag_id value within a base region with a particular regionbase_id value shall have the same value for region_label in the entire timed metadata track.

region_label_present_flag equal to 1 indicates that region_label is present immediately following this element. region_label_present_flag equal to 0 indicates that region_label is not present.
region_label is a NULL-terminated string of UTF-8 characters which provides a human readable label associated with this most-interested region. When region_label is not present its value is inferred to be equal to the value of region_label in this timed metadata track if present in any sample entry with the same value for region_tag_id as this sample entry's region_tag_id value or NULL otherwise.

The syntax and semantics for signaling most-interested regions provided in Choi described above, only allows indication of most-interested regions on packed frame. Some of the use cases corresponding to most-interested region are more suitable for indication of the most-interested region on projected frame instead of on the packed frame. These include any use cases which relate to indicating a region on the rendered frame. For example, use cases including a Director view on the sphere, and initial viewpoint for on-demand content can benefit from indication on 2D projected frame. In these cases, the most-interested region may simply be metadata information which is useful for rendering purposes. Further, the syntax of most-interested regions can be easily extended as shown below with a flag to indicate whether the indicated most-interested region is on a packed frame or on a projected frame.

unsigned int(32) regionbase_id;
unsigned int(16) entry_count;
for (i=1; i<= entry_count; i++) {

unsigned int(16) left_horizontal_offset;
unsigned int(16) top_vertical_offset;
unsigned int(16) region_width;
unsigned int(16) region_height;
unsigned int(1) region_on_frame_flag;

}

where:
region_on_frame_flag equal to 1 indicates that this most-interested region identified by left_horizontal_offset, top_vertical_offset, region_width, and region_height is indicated on the packed frame, region_on_frame_flag equal to 0 indicates that this most-interested region identified by left_horizontal_offset, top_vertical_offset, region_width, and region_height values is indicated on the projected frame.

It should be noted that when both the signal techniques above are used together, the region_on_frame_flag can be signaled before region_tag_id and 14 bits can be used for region_tag_id. Thus, overall syntax can be as shown below:

aligned(8) class MirSample( ){

unsigned int(32) regionbase_id;
unsigned int(16) entry_count;
for (i=1; i<= entry_count; i++) {

unsigned int(32) left_horizontal_offset;
unsigned int(32) top_vertical_offset;
unsigned int(32) region_width;
unsigned int(32) region_height;
unsigned int(1) region_on_frame_flag;
unsigned int(14) region_tag_id;
unsigned int(1) region_label_present_flag;
if (region_label_present_flag) {

string region_label;

}

}

}

In one example, data encapsulator 107 may be configured to signal most-interested regions according to the following syntax and semantics:

### Syntax

unsigned int(32) regionbase_id;
unsigned int(16) entry_count;
for (i=1; i<= entry_count; i++) {

unsigned int(16) left_horizontal_offset;
unsigned int(16) top_vertical_offset;
unsigned int(16) region_width;
unsigned int(16) region_height;
unsigned int(1) ioh_mir;
bit(7) reserved = 0;

}

### Semantics

NOTE 1: As the sample structure extends from RegionOnSphereSample, the syntax elements of RegionOnSphereSample are included in the sample.
regionbase_id specifies the base region against which the positions and sizes of the most-interested regions are specified.
entry_count specifies the number of entries.
left_horizontal_offset, top_vertical_offset, region_width, and region_height are integer values that indicate the position and size of the most-interested region. left_horizontal_offset and top_vertical_offset indicate the horizontal and vertical coordinates, respectively, in luma samples, of the upper left corner of the most-interested region in relative to the base region. region_width and region_height indicate the width and height, respectively, in luma samples, of the most-interested region in relative to the base region.
ioh_mir equal to 0 specifics that the indicated values left_horizontal_offset, top_vertical_offset, region_width, and region_height in this timed metadata track shall be used for samples in the referenced track until the next occurrence of these values in the timed metadata track. ioh_mir equal to 1 specifies that the indicated values left_horizontal_offset, top_vertical_offset, region_width, and region_height in this timed metadata track should be linearly interpolated between successive samples.

According to the techniques described herein, one or more of the following constraints and semantics changes may be used for syntax elements for number of entry counts and rectangle parameters for most-interested regions. These may include one or more of the following: the regionbase_id is specified to indicate the track_ID value, with value 0 reserved; a constraint is included on entry_count; constraints are included on the left_horizontal_offset, top_vertical_offset, region_width, and region_height to enforce avoiding signaling values, which can fall outside the packed frame. In one example, these constraints may be implemented according to the following semantics:

regionbase_id specifies the base region against which the positions and sizes of the most-interested regions are specified. In another example regionbase_id specifies the track_ID which corresponds to a track in ISOMBFF file against which the positions and sizes of the most-interested regions are specified. The value of 0 is reserved.

entry_count specifies the number of entries. entry_count shall be greater than 0. In an example the value of 0 is reserved. In another example this element may instead be signalled as entry_count_minus1 which plus 1 specifies the number of entries.

left_horizontal_offset, top_vertical_offset, region_width, and region_height are integer values that indicate the position and size of the most-interested region. left_horizontal_offset and top_vertical_offset indicate the horizontal and vertical coordinates, respectively, in luma samples, of the upper left corner of the most-interested region in relative to the base region. region_width and region_height indicate the width and height, respectively, in luma samples, of the most-interested region in relative to the base region.

If no RegionWisePackingBox is present (i.e. region-wise packing is not used),
For each i in the range of 1 to entry_count (left_horizontal_offset+region_width) shall be less than proj_frame_width.
For each i in the range of 1 to entry_count (top_vertical_offset+region_height) shall be less than proj_frame_height.

In one example, the most-interested region rectangle indicated by left_horizontal_offset, top_vertical_offset, region_width, and region_height shall completely span within the packed frame. When the packed frame is stereoscopic the most-interested region rectangle indicated by left_horizontal_offset, top_vertical_offset, region_width, and region_height shall completely span within a single constituent frame of packed frame.

In one example, the most-interested region rectangle indicated by left_horizontal_offset, top_vertical_offset, region_width, and region_height shall completely span within the packed frame when region_on_frame_flag is equal to 1 or shall completely span within the projected frame when region_on_frame_flag is equal to 0. When the packed frame is stereoscopic the most-interested region rectangle indicated by left_horizontal_offset, top_vertical_offset, region_width, and region_height shall completely span within a single constituent frame of the packed frame when region_on_frame_flag is equal to 1 or shall completely span within within a single constituent frame of the projected frame when region_on_frame_flag is equal to 0.

With respect to the example syntax and semantics provided above, data encapsulator 107 may be configured to signal a syntax element indicating whether a region's position and size are indicated on a packed frame or a projected frame.

Referring to the RegionOnSphereConfigBox syntax and semantics provided in Choi described above, in one example, data encapsulator 107 may be configured to more efficiently signal RegionOnSphereConfigBox. In one example, data encapsulator 107 may be configured to signal static_hor_range and static_ver_range, such that static_hor_range shall be in the range of 1 to 36000, inclusive and/or static_ver_range shall be in the range of 1 to 18000, inclusive. In another example, static_hor_range shall be in the range of 0 to 36000, inclusive. Static_ver_range shall be in the range of 0 to 18000, inclusive. In these examples, the value of 0 is allowed for static_hor_range and static_ver_range. This allows indicating a point on the sphere. In certain use cases, for example, indicating reticle or crosshair or gaze pointer it may be important to indicate a point instead of region on the sphere. Thus, according to the techniques described herein, such a point on the sphere indication possible.

Further, in one example, data encapsulator 107 may be configured to signal RegionOnSphereConfigBox according to the following example syntax and semantics:

class RegionOnSphereSampleEntry extends
MetaDataSampleEntry(‘rosp’) {

RegionOnSphereConfigBox( ); // mandatory
Box[ ] other_boxes; // optional

}
class RegionOnSphereConfigBox extends FullBox(‘rosc’, version = 0,
flags) {

unsigned int(8) shape_type;
bit(7) reserved = 0;
unsigned int(1) dynamic_range_flag;
if (dynamic_range_flag == 0) {

unsigned int(32) static_hor_range;
unsigned int(32) static_ver_range;

}
unsigned int(16) num_regions;

}

### Semantics

shape_type equal to 0 specifies that the region is specified by four great circles.
shape_type equal to 1 specifies that the region is specified by two yaw circles and two pitch circles,
shape_type values greater than 1 are reserved.
dynamic_range_flag equal to 0 specifies that the horizontal and vertical ranges of the region remain unchanged in all samples referring to this sample entry. dynamic_range_flag equal to 1 specifies that the horizontal and vertical ranges of the region is indicated in the sample format.
static_hor_range and static_ver_range specify the horizontal and vertical ranges, respectively, of the region for each sample referring to this sample entry in units of 2⁻¹⁶ degrees. static_hor_range shall be in the range of 0 to 720*65536, inclusive. static_ver_range shall be in the range of 0 to 360*65536, inclusive, static_hor_range and static_ver_range specify the ranges through the center point of the region.
It is noted that the value 0 is allowed for static_hor_range and static_ver_range to allow indication of a point on the sphere. In this case in some examples the region may have zero area.
num_regions specifies the number of regions in the samples referring to this sample entry. num_regions shall be equal to 1. Other values of num_regions are reserved.

Thus, according to the techniques described herein, data encapsulator 107 may be configured to enable enhanced precision for angular values.

Referring to the RegionOnSphereStruct syntax and semantics provided in Choi described above, in one example, data encapsulator 107 may be configured to more efficiently signal RegionOnSphereStruct. In one example, data encapsulator 107 may be configured to signal RegionOnSphereStruct according to the following syntax:

aligned(8) RegionOnSphereStruct(range_included_flag) {

signed int(16) center_yaw;
signed int(15) center_pitch;
bit(1) reserved = 0;
if (range_included_flag) {

unsigned int(16) hor_range;
unsigned int(16) ver_range;

}
aligned(8) RegionOnSphereSample( ) {

for (i = 0; i < num_regions; i++)

RegionOnSphereStruct(dynamic_range_flag)

}

In this case, the following example semantics may be utilized:
When RegionOnSphereStruct( ) is included in the RegionOnSphereSample( )structure, the following applies:
center_yaw and center_pitch specify the center point of the region specified by this sample in units of 0.01 degrees relative to the global coordinate system. center_yaw shall be in the range of −18000 to 17999, inclusive. center_pitch shall be in the range of −9000 to 9000, inclusive.
hor_range and ver_range, when present, specify the horizontal and vertical ranges, respectively, of the region specified by this sample in units of 0.01 degrees. hor_range and ver_range specify the range through the center point of the region.
hor_range when present shall be in the range of 1 to 36000, inclusive. ver_range when present shall be in the range of 1 to 18000, inclusive.

In another example, hor_range when present shall be in the range of 0 to 36000, inclusive. ver_range when present shall be in the range of 0 to 18000, inclusive. In this case the value of 0 is allowed for hor_range and ver_range. This allows indicating a point on the sphere.

When range_included_flag is equal to 1 center_pitch+ver_range÷2 shall not be greater than 9000 and center_pitch−ver_range÷2 shall not be less than −9000.
When range_included_flag is equal to 1 center_yaw+hor_range÷2 shall not be greater than 17999 and center_yaw−hor_range÷2 shall not be less than −18000.
When range_included_flag is equal to 0 center_pitch+static_ver_range÷2 shall not be greater than 9000 and center_pitch−static_ver_range÷2 shall not be less than −9000.
When range_included_flag is equal to 0 center_yaw+static_hor_range÷2 shall not be greater than 17999 and center_yaw−static_hor_range÷2 shall not be less than −18000.

In another example, instead of or in addition to the above constraints the following constraints may be specified:
When range_included_flag is equal to 1:
   When center_pitch+ver_range÷2 is greater than 9000, it will be calculated as (center_pitch+ver_range÷2 −18000)
   When center_pitch−ver_range÷2 is less than −9000, it will be calculated as (center_pitch+ver_range÷2+18000)
   When center_yaw+hor_range÷2 is greater than 17999, it will be calculated as (center_yaw+hor_range÷2 −36000)
   When center_yaw−hor_range÷2 is less than −18000, it will be calculated as (center_yaw+hor_range÷2+36000)
When range_included_flag is equal to 0:
   When center_pitch+static_ver_range÷2 is greater than 9000, it will be calculated as (center_pitch+static_ver_range÷2 −18000)
   When center_pitch−static_ver_range÷2 is less than −9000, it will be calculated as (center_pitch+static_ver_range÷2+18000)
   When center_yaw+static_hor_range÷2 is greater than 17999, it will be calculated as (center_yaw+static_hor_range÷2 −36000)
   When center_yaw−static_hor_range÷2 is less than −18000, it will be calculated as (center_yaw+static_hor_range÷2+36000)

Further, in one example, data encapsulator 107 may be configured to signal RegionOnSphereStruct according to the following syntax and semantics:

### Syntax

aligned(8) RegionOnSphereStruct(range_included_flag) {

signed int(32) center_yaw;
signed int(32) center_pitch;
signed int(32) center_roll;
if (range_included_flag) {

unsigned int(32) hor_range;
unsigned int(32) ver_range;

}
aligned(8) RegionOnSphereSample( ) {

for (i = 0; i < num_regions; i++)

RegionOnSphereStruct(dynamic_range_flag)

}

### Semantics

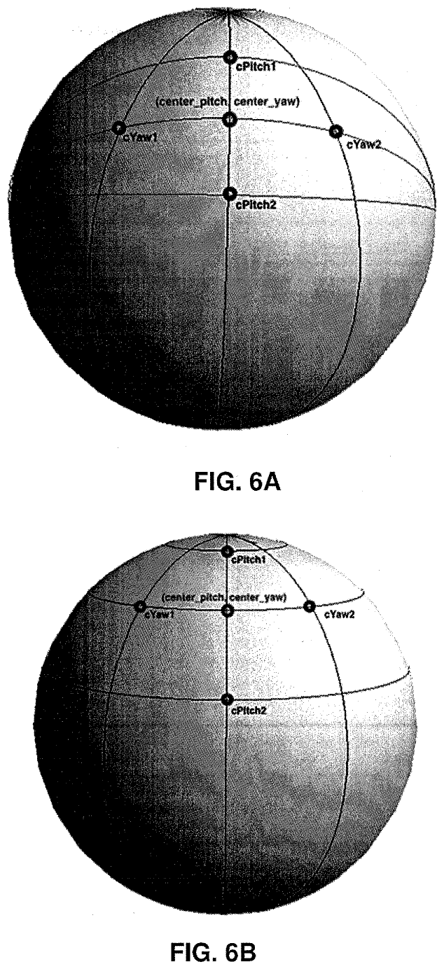

When RegionOnSphereStruct( ) is included in the RegionOnSphereSample( )structure, the following applies:
center_yaw, and center_pitch, and center_roll specify the center point of the region specified by this sample in units of 2⁻¹⁶ degrees relative to the global coordinate system, respectively. center_yaw shall be in the range of −180*2⁻¹⁶ to (180*2¹⁶)−1, inclusive. center_pitch shall be in the range of −90*2¹⁶ to 90*2¹⁶, inclusive. center_roll shall be in the range of −180*2¹⁶ to (180*2¹⁶)−1, inclusive
hor_range and ver_range, when present, specify the horizontal and vertical ranges, respectively, of the region specified by this sample in units of 2⁻¹⁶ degrees, respectively. hor_range shall be in the range of 0 to 720*65536, inclusive. ver_range shall be in the range of 0 to 360*360, inclusive. hor_range and ver_range specify the range through the center point of the region.
It is noted that the value 0 is allowed for hor_range and ver_range to allow indication of a point on the sphere. In this case in some examples the region may have zero area.
The region on sphere is defined using variables cYaw1, cYaw2, cPitch1, cPitch2 derived as follows:
cYaw1=(((center_yaw−(range_included_flag?hor_range:static_hor_range)÷2) <−18000)?((center_yaw−(range_included_flag?hor_range:static_hor_range)÷2)+36000:((center_yaw−(range_included_flag?hor_range:static_hor_range)÷2))*0.01*π÷180
cYaw2=(((center_yaw+(range_included_flag?hor_range:static_hor_range)÷2)>17999)?(center_yaw+(range_included_flag?hor_range static_hor_range)÷2)−36000:(((center_yaw+(range_included_flag?hor_range:static_hor_range)÷2))*0.01*π÷180
cPitch1=(((center_pitch−(range_included_flag?ver_range:static_ver_range)÷2)<−9000?(center_pitch−(range_included_flag?ver_range:static_ver_range) ÷2)+18000:(center_pitch−(range_included_flag?ver_range:static_ver_range)÷2))*0.01*π÷180
cPitch2=(((center_pitch+(range_included_flag?ver_range:static_ver_range)÷2)>9000?(center_pitch+(range_included_flag?ver_range:static_ver_range)÷2)−18000:(center_pitch+(range_included_flag?ver_range:static_ver_range)÷2))*0.01*π÷180
If shape_type is equal to 0, region is specified by four great circles defined by four points cYaw1, cYaw2, cPitch1, cPitch2 in radians defined by equations above and the center point defined by center_pitch and center_yaw and as shown in FIG. 6A.
If shape_type is equal to 1 the region is specified by two yaw circles and two pitch circles defined by four points cYaw1, cYaw2, cPitch1, cPitch2 in radians defined by equations above and the center point defined by center_pitch and center_yaw and as shown in FIG. 6B.
If binary angle measurement with 16 bits is used:
   The region on sphere is defined using variables cYaw1, cYaw2, cPitch1, cPitch2 derived as follows:
cYaw1=(center_yaw−(range_included_flag?hor_range:static_hor_range)÷2)* (1÷65536)*π÷180
cYaw2=(center_yaw+(range_included_flag?hor_range:static_hor_range)÷2)* (1+65536)*π÷180
cPitch1=(center_pitch−(range_included_flag?ver_range:static_ver_range)÷2)* (1+65536)*π÷180
cPitch2=(center_pitch+(range_included_flag?ver_range:static_ver_range)÷2)* (1+65536)*π÷180
If 16.16 fixed point representation is used:
   The region on sphere is defined using variables cYaw1, cYaw2, cPitch1, cPitch2 derived as follows:
cYaw1=(center_yaw−(range_included_flag?hor_range:static_hor_range)÷2)* (360÷4294967296)*π÷180
cYaw2=(center_yaw+(range_included_flag?hor_range:static_hor_range)÷2)* (360÷4294967296)*π÷180
cPitch1=(center_pitch−(range_included_flag?ver_range:static_ver_range)÷2)* (180÷4294967296)*π÷180
cPitch2=(center_pitch+(range_included_flag?ver_range:static_ver_range)÷2)* (180÷4294967296)*π÷180
In another example following equations may be used for deriving variables cYaw1, cYaw2, cPitch1, cPitch2:
cYaw1=(((center_yaw−(range_included_flag?hor_range:static_hor_range)÷2)<−18000)?((center_yaw−(range_included_flag?hor_range:static_hor_range)÷2)+36000:((center_yaw−(range_included_flag?hor_range:static_hor_range)÷2)) *(360÷65536)*π÷180
cYaw2=(((center_yaw+(range_included_flag?hor_range:static_hor_range)÷2) >17999)?(center_yaw+(range_included_flag?hor_range:static_hor_range)÷2)−36000:(((center_yaw+(range_included_flag?hor_range:static_hor_range)÷2)) *(360÷65536)*π÷180
cPitch1=(((center_pitch−(range_included_flag?ver_range:static_ver_range)÷2) <-9000?(center_pitch−(range_included_flag?ver_range:static_ver_range)÷2)−18000; (center_pitch−(range_included_flag?ver_range:static_ver_range)÷2))* (180÷65536)*π÷180
cPitch2=(((center_pitch+(range_included_flag?ver_range:static_ver_range)÷2) >9000?(center_pitch+(range_included_flag?ver_range:static_ver_range)÷2)−18000:(center_pitch+(range_included_flag?ver_range:static_ver_range)÷2))* (180÷65536)*π÷180

Thus, according to the techniques described herein, data encapsulator 107 may be configured to enable enhanced precision for angular values.

Referring to the IntialViewpointSample syntax provided in Choi described above, in one example, data encapsulator 107 may be configured to more efficiently signal roll as a signed 16 bit integer. Because a roll angle can vary in the range of −180 to 179.99, inclusive, it may be useful to change the data type of roll in initial viewpoint. Further, the allowed range of roll is changed. In one example, data encapsulator 107 may be configured to more efficiently signal roll using the following syntax and semantics:

### Syntax

class InitialViewpointSample( ) extends RegionOnSphereSample {

signed int(16) roll;
unsigned int(1) refresh_flag;
bit(7) reserved = 0;

}

### Semantics

center_yaw, center_pitch, and roll specify the viewport orientation in units of 0.01 degrees relative to the global coordinate system. center_yaw and center_pitch indicate the center of the viewport, and roll indicates the roll angle of the viewport. roll shall be in the range of −18000 to 17999, inclusive.

Referring to the RegionOnSphereConfigBox syntax provided in Choi described above, in one example, data encapsulator 107 may be configured to more efficiently signal num_regions as a unsigned 8 bit integer. Currently, only one value of num_regions is allowed and defined. Thus, it is required that num_regions shall be equal to 1. It may be more efficient to signal num_regions in RegionOnSphere-ConfigBox as shown below:

### Syntax

class RegionOnSphereSampleEntry extends
MetaDataSampleEntry(‘rosp’) {

RegionOnSphereConfigBox( ); // mandatory
Box[ ] other_boxes; // optional

}
class RegionOnSphereConfigBox extends FullBox(‘rosc’, version = 0,
flags) {

unsigned int(8) shape_type;
bit(7) reserved = 0;
unsigned int(1) dynamic_range_flag;
if (dynamic_range_flag 0) {

unsigned int(16) static_hor_range;
unsigned int(16) static_ver_range;

}
unsigned int(8) num_regions;

}

Referring to the most-interested region signaling syntax provided in Choi described above, in one example, the bit-width of Most-interested region rectangle (left_horizontal_offset, top_vertical_offset, region_width, and region_height) may be signaled using unsigned int (32) to be able to specify complete rectangles consistent with the bit-width of other fields in Choi, as shown below:

unsigned int(32) regionbase_id;
unsigned int(16) entry_count;
for (i=1; i<= entry_count; i++) {

unsigned int(32) left_horizontal_offset;
unsigned int(32) top_vertical_offset;
unsigned int(32) region_width;
unsigned int(32) region_height;

}

Referring to the recommended viewport description provided in Choi described above, the recommended viewport timed metadata track indicates the viewport that should be displayed when the user does not have control of the viewing orientation or has released control of viewing orientation. According to the techniques described herein, data encapsulator 107 may be configured to signal a syntax element which indicates if the previously signaled values in timed metadata track for recommended yaw, pitch and horizontal and vertical ranges are retained or interpolated, which provides for efficient signaling, e.g., compared to signaling a recommended viewport for each sample. In one example, according to the techniques, described herein, data encapsulator 107 may be configured to signal a recommended viewport based on the following example definition, syntax and semantics.

### Definition

The recommended viewport timed metadata track indicates the viewport that should be displayed when the user does not have control of the viewing orientation or has released control of the viewing orientation.
   NOTE: The recommended viewport timed metadata track may be used for indicating a director's cut.
   The sample entry type ‘rcvp’ shall be used.
   The sample syntax of RegionOnSphereSample shall be used.
   shape_type shall be equal to 0 in the RegionOnSphereConfigBox of the sample entry.

### Syntax

class RecommendedViewportSample( ) extends RegionOnSphereSample {

unsigned int(1) ioh;
bit(7) reserved = 0;

}

### Semantics

static_hor_range and static_ver_range, when present, or hor_range and ver_range, when present, indicate the horizontal and vertical fields of view, respectively, of the recommended viewport.
center_yaw and center_pitch indicate the center point of the recommended viewport.
In one example, ioh equal to 0 specifies that the indicated recommended viewport's center_yaw, center_pitch, hor_range (if present) and ver_range (if present) values in this RecommendedViewportSample shall be used for samples in the referenced track until the next RecommendedViewportSample. ioh equal to 1 specifies that the indicated recommended viewport's center_yaw, center_pitch, hor_range (if present) and ver_range (if present) values should be linearly interpolated between successive RecommendedViewportSample's corresponding values.
In one example, ioh equal to 0 specifies that the indicated recommended viewport's center_yaw, center_pitch, static_hor_range when present or hor_range value otherwise, static_ver_range when present or ver_range value otherwise in this RecommendedViewportSample is to be used for samples in the referenced track until the next RecommendedViewportSample. ioh equal to 1 specifies the indicated recommended viewport's center_yaw, center_pitch, static_hor_range when present or hor_range value otherwise, static_ver_range when present or ver_range value shall/should/ may be linearly interpolated between successive RecommendedViewportSample's corresponding values.
In one example, ioh equal to 0 indicates that there shall not be any interpolation of recommended viewport's center_yaw, center_pitch, hor_range (if present) and ver_range (if present) values between the previous and the current samples. ioh equal to 1 indicates that the application may linearly interpolate recommended viewport's center_yaw, center_pitch, hor_range (if present) and ver_range (if present) values between the previous sample and the current sample.
In one example, ioh equal to 0 specifies that the indicated recommended viewport's center_yaw, center_pitch values in this RecommendedViewportSample shall be used for samples in the referenced track until the next RecommendedViewportSample. ioh equal to 1 specifies that the indicated recommended viewport's center_yaw, center_pitch values should be linearly interpolated between successive RecommendedViewportSample's corresponding values.

In another example the above described syntax element unsigned int(1) ioh; may be included in the RegionOnSphereConfigBox as shown in the example below:

### Syntax

class RegionOnSphereSampleEntry extends
MetaDataSampleEntry(‘rosp’) {

RegionOnSphereConfigBox( ); // mandatory
Box[ ] other_boxes; // optional

}
class RegionOnSphereConfigBox extends FullBox(‘rosc’, version = 0,
flags) {

unsigned int(8) shape_type;
bit(6) reserved = 0;
unsigned int(1) ioh;
unsigned int(1) dynamic_range_flag;
if (dynamic_range_flag == 0) {

unsigned int(16) static_hor_range;
unsigned int(16) static_ver_range;
}

unsigned int(8) num_regions;

}

In this case, in one example, ioh equal to 0 specifies that the indicated center_yaw, center_pitch, hor_range (if present) and ver_range (if present) values in this RegionOnSphereConfigBox shall be used for samples in the referenced track until the next RegionOnSphereConfigBox. ioh equal to 1 specifies that the indicated recommended viewport's center_yaw, center_pitch, hor_range (if present) and ver_range (if present) values should be linearly interpolated between successive RegionOnSphereConfigBox's corresponding values.

In another example the above described syntax element unsigned int(1) ioh; may be included in the RegionOnSphereStruct as shown below:

aligned(8) RegionOnSphereStruct(range_included_flag) {

signed int(16) center_yaw;
signed int(15) center_pitch;
unsigned int(1) ioh;
if (range_included_flag) {

unsigned int(16) hor_range;
unsigned int(16) ver_range;

}
aligned(8) RegionOnSphereSample( ) {

for (i = 0; i < num_regions; i++)

RegionOnSphereStruct(dynamic_range_flag)

}

In this case, in one example, ioh equal to 0 specifics that the indicated center_yaw, center_pitch, hor_range (if present) and ver_range (if present) values in this RegionOnSphereStruct shall be used for samples in the referenced track until the next RegionOnSphereStruct. ioh equal to 1 specifies that the indicated recommended viewport's center_yaw, center_pitch, hor_range (if present) and ver_range (if present) values should be linearly interpolated between successive RegionOnSphereStruct's corresponding values.

It should be noted that in one example, respective flags may be included in the recommended viewport syntax to indicate if yaw, pitch, horizontal and vertical ranges are interpolated or held between consecutive timed metadata track samples. In examples where these respective flags are included in the recommended viewport syntax, the syntax and semantics may be based on the example syntax and semantics provided below:

### Syntax

class RecommendedViewportSample( ) extends RegionOnSphereSample {

unsigned int(1) ioh_yaw;
unsigned int(1) ioh_pitch;
unsigned int(1) ioh_hrange;
unsigned int(1) ioh_vrange;

bit(4) reserved = 0;

}

### Semantics

NOTE 1:As the sample structure extends from RegionOnSphereSample, the syntax elements of RegionOnSphereSample are included in the sample.
static_hor_range and static_ver_range, when present, or hor_range and ver_range, when present, indicate the horizontal and vertical fields of view, respectively, of the recommended viewport.
center_yaw and center_pitch indicate the center point of the recommended viewport.
ioh equal to 0 specifies that the indicated recommended viewport's center_yaw, center_pitch, hor_range value if present and ver_range value if present in this RecommendedViewportSample shall be used for samples in the referenced track until the next RecommendedViewportSample. ioh equal to 1 specifies the indicated recommended viewport's center_yaw, center_pitch, hor_range value if present and ver_range value if present should be linearly interpolated between successive RecommendedViewportSample's corresponding values.
ioh_yaw equal to 0 specifies that the indicated recommended viewport's center_yaw value in this RecommendedViewportSample shall be used for samples in the referenced track until the next RecommendedViewportSample. ioh_yaw equal to 1 specifies the indicated recommended viewport's center_yaw value should be linearly interpolated between successive RecommendedViewportSample's center_yaw values.
ioh_pitch equal to 0 specifies that the indicated recommended viewport's center_pitch value in this RecommendedViewportSample shall be used for samples in the referenced track until the next RecommendedViewportSample. ioh_pitch equal to 1 specifies the indicated recommended viewport's center_pitch value should be linearly interpolated between successive RecommendedViewportSample's center_pitch values,
ioh_hrange equal to 0 specifies that the indicated recommended viewport hor_range value if present in this RecommendedViewportSample shall be used for samples in the referenced track until the next RecommendedViewportSample. ioh_hrange equal to 1 specifies the indicated recommended viewport's hor_range value if present should be linearly interpolated between successive RecommendedViewportSample's hor_range values.
ioh_vrange equal to 0 specifies that the indicated recommended viewport ver_range value if present in this RecommendedViewportSample shall be used for samples in the referenced track until the next RecommendedViewportSample. ioh_vrange equal to 1 specifies the indicated recommended viewport's ver_range value if present should be linearly interpolated between successive RecommendedViewportSample's ver_range values.

It should be noted that in one example, the interpolated value may be held until the next sample.

Referring again to FIG. 1, interface 108 may include any device configured to receive data generated by data encapsulator 107 and transmit and/or store the data to a communications medium. Interface 108 may include a network interface card, such as an Ethernet card, and may include an optical transceiver, a radio frequency transceiver, or any other type of device that can send and/or receive information. Further, interface 108 may include a computer system interface that may enable a file to be stored on a storage device. For example, interface 108 may include a chipset supporting Peripheral Component Interconnect (PCI) and Peripheral Component Interconnect Express (PCIe) bus protocols, proprietary bus protocols, Universal Serial Bus (USB) protocols, I²C, or any other logical and physical structure that may be used to interconnect peer devices.

Referring again to FIG. 1, destination device 120 includes interface 122, data decapsulator 123, video decoder 124, and display 126. Interface 122 may include any device configured to receive data from a communications medium. Interface 122 may include a network interface card, such as an Ethernet card, and may include an optical transceiver, a radio frequency transceiver, or any other type of device that can receive and/or send information. Further, interface 122 may include a computer system interface enabling a compliant video bitstream to be retrieved from a storage device. For example, interface 122 may include a chipset supporting PCI and PCIe bus protocols, proprietary bus protocols, USB protocols, I²C, or any other logical and physical structure that may be used to interconnect peer devices. Data decapsulator 123 may be configured to receive a bitstream and metadata generated by data encapsulator 107 and perform a reciprocal decapsulation process.

Video decoder 124 may include any device configured to receive a bitstream and/or acceptable variations thereof and reproduce video data therefrom. Display 126 may include any device configured to display video data. Display 126 may comprise one of a variety of display devices such as a liquid crystal display (LCD), a plasma display, an organic light emitting diode (OLED) display, or another type of display. Display 126 may include a High Definition display or an Ultra High Definition display. Display 126 may include a stereoscopic display. It should be noted that although in the example illustrated in FIG. 1, video decoder 124 is described as outputting data to display 126, video decoder 124 may be configured to output video data to various types of devices and/or sub-components thereof. For example, video decoder 124 may be configured to output video data to any communication medium, as described herein. Destination device 120 may include a receiver device.

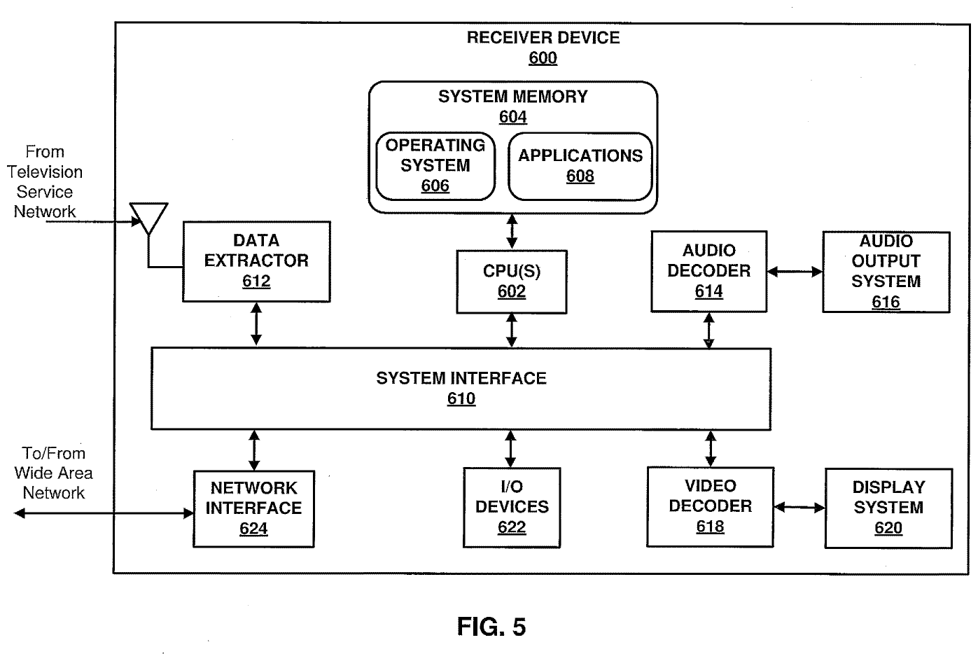

FIG. 5 is a block diagram illustrating an example of a receiver device that may implement one or more techniques of this disclosure. That is, receiver device 600 may be configured to parse a signal based on the semantics described above. Receiver device 600 is an example of a computing device that may be configured to receive data from a communications network and allow a user to access multimedia content, including a virtual reality application. In the example illustrated in FIG. 5, receiver device 600 is configured to receive data via a television network, such as, for example, television service network 404 described above. Further, in the example illustrated in FIG. 5, receiver device 600 is configured to send and receive data via a wide area network. It should be noted that in other examples, receiver device 600 may be configured to simply receive data through a television service network 404. The techniques described herein may be utilized by devices configured to communicate using any and all combinations of communications networks.

As illustrated in FIG. 5, receiver device 600 includes central processing unit(s) 602, system memory 604, system interface 610, data extractor 612, audio decoder 614, audio output system 616, video decoder 618, display system 620, I/O device(s) 622, and network interface 624. As illustrated in FIG. 5, system memory 604 includes operating system 606 and applications 608. Each of central processing unit(s) 602, system memory 604, system interface 610, data extractor 612, audio decoder 614, audio output system 616, video decoder 618, display system 620, I/O device(s) 622, and network interface 624 may be interconnected (physically, communicatively, and/or operatively) for inter-component communications and may be implemented as any of a variety of suitable circuitry, such as one or more microprocessors, digital signal processors (DSPs), application specific integrated circuits (ASICs), field programmable gate arrays (FPGAs), discrete logic, software, hardware, firmware or any combinations thereof. It should be noted that although receiver device 600 is illustrated as having distinct functional blocks, such an illustration is for descriptive purposes and does not limit receiver device 600 to a particular hardware architecture. Functions of receiver device 600 may be realized using any combination of hardware, firmware and/or software implementations.

CPU(s) 602 may be configured to implement functionality and/or process instructions for execution in receiver device 600. CPU(s) 602 may include single and/or multi-core central processing units. CPU(s) 602 may be capable of retrieving and processing instructions, code, and/or data structures for implementing one or more of the techniques described herein. Instructions may be stored on a computer readable medium, such as system memory 604.

System memory 604 may be described as a non-transitory or tangible computer-readable storage medium. In some examples, system memory 604 may provide temporary and/or long-term storage. In some examples, system memory 604 or portions thereof may be described as non-volatile memory and in other examples portions of system memory 604 may be described as volatile memory. System memory 604 may be configured to store information that may be used by receiver device 600 during operation. System memory 604 may be used to store program instructions for execution by CPU(s) 602 and may be used by programs running on receiver device 600 to temporarily store information during program execution. Further, in the example where receiver device 600 is included as part of a digital video recorder, system memory 604 may be configured to store numerous video files.

Applications 608 may include applications implemented within or executed by receiver device 600 and may be implemented or contained within, operable by, executed by, and/or be operatively/communicatively coupled to components of receiver device 600. Applications 608 may include instructions that may cause CPU(s) 602 of receiver device 600 to perform particular functions. Applications 608 may include algorithms which are expressed in computer programming statements, such as, for-loops, while-loops, if-statements, do-loops, etc. Applications 608 may be developed using a specified programming language. Examples of programming languages include, Java™, Jini™, C, C++, Objective C, Swift, Perl, Python, PhP, UNIX Shell, Visual Basic, and Visual Basic Script. In the example where receiver device 600 includes a smart television, applications may be developed by a television manufacturer or a broadcaster. As illustrated in FIG. 5, applications 608 may execute in conjunction with operating system 606. That is, operating system 606 may be configured to facilitate the interaction of applications 608 with CPUs(s) 602, and other hardware components of receiver device 600. Operating system 606 may be an operating system designed to be installed on set-top boxes, digital video recorders, televisions, and the like. It should be noted that techniques described herein may be utilized by devices configured to operate using any and all combinations of software architectures.

System interface 610 may be configured to enable communications between components of receiver device 600. In one example, system interface 610 comprises structures that enable data to be transferred from one peer device to another peer device or to a storage medium. For example, system interface 610 may include a chipset supporting Accelerated Graphics Port (AGP) based protocols, Peripheral Component Interconnect (PCI) bus based protocols, such as, for example, the PCI Express™ (PCIe) bus specification, which is maintained by the Peripheral Component Interconnect Special Interest Group, or any other form of structure that may be used to interconnect peer devices (e.g., proprietary bus protocols).

As described above, receiver device 600 is configured to receive and, optionally, send data via a television service network. As described above, a television service network may operate according to a telecommunications standard. A telecommunications standard may define communication properties (e.g., protocol layers), such as, for example, physical signaling, addressing, channel access control, packet properties, and data processing. In the example illustrated in FIG. 5, data extractor 612 may be configured to extract video, audio, and data from a signal. A signal may be defined according to, for example, aspects DVB standards, ATSC standards, ISDB standards, DTMB standards, DMB standards, and DOCSIS standards.

Data extractor 612 may be configured to extract video, audio, and data, from a signal. That is, data extractor 612 may operate in a reciprocal manner to a service distribution engine. Further, data extractor 612 may be configured to parse link layer packets based on any combination of one or more of the structures described above.

Data packets may be processed by CPU(s) 602, audio decoder 614, and video decoder 618. Audio decoder 614 may be configured to receive and process audio packets. For example, audio decoder 614 may include a combination of hardware and software configured to implement aspects of an audio codec. That is, audio decoder 614 may be configured to receive audio packets and provide audio data to audio output system 616 for rendering. Audio data may be coded using multi-channel formats such as those developed by Dolby and Digital Theater Systems. Audio data may be coded using an audio compression format. Examples of audio compression formats include Motion Picture Experts Group (MPEG) formats, Advanced Audio Coding (AAC) formats, DTS-HD formats, and Dolby Digital (AC-3) formats. Audio output system 616 may be configured to render audio data. For example, audio output system 616 may include an audio processor, a digital-to-analog converter, an amplifier, and a speaker system. A speaker system may include any of a variety of speaker systems, such as headphones, an integrated stereo speaker system, a multi-speaker system, or a surround sound system.

Video decoder 618 may be configured to receive and process video packets. For example, video decoder 618 may include a combination of hardware and software used to implement aspects of a video codec. In one example, video decoder 618 may be configured to decode video data encoded according to any number of video compression standards, such as ITU-T H.262 or ISO/IEC MPEG-2 Visual, ISO/IEC MPEG-4 Visual, ITU-T H.264 (also known as ISO/IEC MPEG-4 Advanced video Coding (AVC)), and High-Efficiency Video Coding (HEVC). Display system 620 may be configured to retrieve and process video data for display. For example, display system 620 may receive pixel data from video decoder 618 and output data for visual presentation. Further, display system 620 may be configured to output graphics in conjunction with video data, e.g., graphical user interfaces. Display system 620 may comprise one of a variety of display devices such as a liquid crystal display (LCD), a plasma display, an organic light emitting diode (OLED) display, or another type of display device capable of presenting video data to a user. A display device may be configured to display standard definition content, high definition content, or ultra-high definition content.

I/O device(s) 622 may be configured to receive input and provide output during operation of receiver device 600. That is, I/O device(s) 622 may enable a user to select multimedia content to be rendered. Input may be generated from an input device, such as, for example, a push-button remote control, a device including a touch-sensitive screen, a motion-based input device, an audio-based input device, or any other type of device configured to receive user input. I/O device(s) 622 may be operatively coupled to receiver device 600 using a standardized communication protocol, such as for example, Universal Serial Bus protocol (USB), Bluetooth, ZigBee or a proprietary communications protocol, such as, for example, a proprietary infrared communications protocol.

Network interface 624 may be configured to enable receiver device 600 to send and receive data via a local area network and/or a wide area network. Network interface 624 may include a network interface card, such as an Ethernet card, an optical transceiver, a radio frequency transceiver, or any other type of device configured to send and receive information. Network interface 624 may be configured to perform physical signaling, addressing, and channel access control according to the physical and Media Access Control (MAC) layers utilized in a network. Receiver device 600 may be configured to parse a signal generated according to any of the techniques described above. In this manner, receiver device 600 represents an example of a device configured parse one or more syntax elements including information associated with a virtual reality application

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Moreover, each functional block or various features of the base station device and the terminal device used in each of the aforementioned embodiments may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

Various examples have been described. These and other examples are within the scope of the following claims.

1. A method of outputting video data for display based on information associated with a virtual reality application, the method comprising:
receiving a signal including metadata including information specifying how a source rectangular region of a projected picture is packed onto a destination rectangular region of a packed picture, wherein the metadata includes a plurality of syntax elements;
parsing one or more syntax elements from the metadata, wherein parsing one or more syntax elements from the metadata includes parsing a 3-bit syntax element having a value that indicates one of one of eight possible transform types; and
outputting video data to a display based on one or more values of the parsed syntax elements.

2. The method of claim 1, wherein the 3-bit syntax element having a value of 0 indicates a transform type.

3. The method of claim 2, wherein the 3-bit syntax element is included in a byte with 5 reserved bits immediately subsequent to the 3-bit syntax element.

4. The method of claim 3, wherein parsing one or more syntax elements from the metadata further includes parsing four 2-byte syntax elements specifying the destination rectangular region of a packed picture, wherein the four 2-byte syntax elements are immediately subsequent to the 5 reserved bits.

5. The method of claim 4, wherein the four 2-byte syntax elements include respective syntax elements specifying a width, a height, a top sample row, and a left-most sample column of the destination rectangular region of a packed picture.

6. The method of claim 1, further comprising:
receiving a signal including metadata including information corresponding to a region which is a subset of a video region, wherein the metadata includes a syntax element providing a human-readable label associated with the region.

7. The method of claim 6, wherein the syntax element providing a human-readable label associated with the region is a NULL-terminated string of UTF-8 characters.

8. A device comprising one or more processors configured to:
receive a signal including metadata including information specifying how a source rectangular region of a projected picture is packed onto a destination rectangular region of a packed picture, wherein the metadata includes a plurality of syntax elements;
parse one or more syntax elements from the metadata, wherein parsing one or more syntax elements from the metadata includes parsing a 3-bit syntax element having a value that indicates one of one of eight possible transform types; and
output video data to a display based on one or more values of the parsed syntax elements.

9. The device of claim 8, wherein the 3-bit syntax element having a value of 0 indicates a transform type.

10. The device of claim 9, wherein the 3-bit syntax element is included in a byte with 5 reserved bits immediately subsequent to the 3-bit syntax element.

11. The device of claim 10, wherein parsing one or more syntax elements from the metadata further includes parsing four 2-byte syntax elements specifying the destination rectangular region of a packed picture, wherein the four 2-byte syntax elements are immediately subsequent to the 5 reserved bits.

12. The device of claim 11, wherein the four 2-byte syntax elements include respective syntax elements specifying a width, a height, a top sample row, and a left-most sample column of the destination rectangular region of a packed picture.

13. The device claim 8, wherein the one or more processors are further configured to:
receive a signal including metadata including information corresponding to a region which is a subset of a video region, wherein the metadata includes a syntax element providing a human-readable label associated with the region.

14. The device of claim 13, wherein the syntax element providing a human-readable label associated with the region is a NULL-terminated string of UTF-8 characters.

15. A non-transitory computer-readable storage medium comprising instructions stored thereon that, when executed, cause one or more processors of a device to:
receive a signal including metadata including information specifying how a source rectangular region of a projected picture is packed onto a destination rectangular region of a packed picture, wherein the metadata includes a plurality of syntax elements;
parse one or more syntax elements from the metadata, wherein parsing one or more syntax elements from the metadata includes parsing a 3-bit syntax element having a value that indicates one of one of eight possible transform types; and
output video data to a display based on one or more values of the parsed syntax elements.

16. The non-transitory computer-readable storage medium of claim 15, wherein the 3-bit syntax element having a value of 0 indicates a transform type.

17. The non-transitory computer-readable storage medium of claim 16, wherein the 3-bit syntax element is included in a byte with 5 reserved bits immediately subsequent to the 3-bit syntax element.

18. The non-transitory computer-readable storage medium of claim 17, wherein parsing one or more syntax elements from the metadata further includes parsing four 2-byte syntax elements, wherein the four 2-byte syntax elements are immediately subsequent to the 5 reserved bits.

19. The non-transitory computer-readable storage medium of claim 18, wherein the four 2-byte syntax elements include respective syntax elements specifying a width, a height, a top sample row, and a left-most sample column of the destination rectangular region of a packed picture.

20. The non-transitory computer-readable storage medium of claim 15, wherein the instructions further cause one or more processors to:
receive a signal including metadata including information corresponding to a region which is a subset of a video region, wherein the metadata includes a syntax element providing a human-readable label associated with the region, wherein the syntax element providing a human-readable label associated with the region is a NULL-terminated string of UTF-8 characters.
